(19) United States
(12) Patent Application Publication
(10) Pub. No.: US 2026/0299749 A1
(43) Pub. Date: Oct. 1, 2026

(54) CONTENT EDITING AND GENERATION SERVICE AND GRAPHICAL USER INTERFACE FOR A CONTENT COLLABORATION PLATFORM

(71) Applicant: Atlassian Pty Ltd., Sydney (AU)

(72) Inventors: Ethan Yew, Sydney (AU); Brian Feldman, Frederick, MD (US); Mathew Chalison, Vista, CA (US); Chris Kimber, Christchurch City (NZ); Stephan Curiskis, Sydney (AU); Alexey Shpakov, Sydney (AU); Matthew Robertson, Brisbane (AU); Anthony Manchin, Adelaide (AU)

(21) Appl. No.: 19/096,632

(22) Filed: Mar. 31, 2025

(51) Int. Cl. G06F 3/0482; G06F 40/166; G06F 40/40

(52) U.S. Cl. CPC G06F 3/0482; G06F 40/166; G06F 40/40

(57) ABSTRACT

Embodiments described herein relate to systems and methods for generating content recommendations for a content item of a content collaboration platform. Content of a current content item is analyzed to define a set of content segments. A respective content recommendation engine is selected for each content segment in accordance with a determined content segment type or classifier. Generative output produced using the content recommendation engines is displayed as a set of selectable recommendation objects in a recommendation region of the interface. User input with respect to the objects can be used to cause modification of the current content within the interface.

### TECHNICAL FIELD

Embodiments described herein relate to content collaboration platforms and, in particular, to systems and methods for generating content to be displayed in a graphical user interface of the content collaboration platform.

### BACKGROUND

An organization can establish a collaborative work environment by self-hosting, or providing its employees with access to, a suite of discrete software platforms or services to facilitate cooperation and completion of work. In systems in which users generate a significant portion of the content in the system through product documentation, source code, or other user-generated content items, the quality and format of the content can vary widely from user-to-user and from group-to-group. The systems and techniques described herein are directed to automated content classification and analysis operations that can be used to present in-context generative content recommendations within a content-creation user interface.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a system diagram that can include and/or may receive input from a generative output engine in accordance with aspects described herein.

FIG. 2A depicts an example system and process flow for content generation in accordance with aspects described herein.

FIG. 2B depicts another example system and process flow for content generation in accordance with aspects described herein.

FIG. 3 depicts an example frontend interface that supports content generation in a content collaboration platform in accordance with aspects described herein.

FIGS. 4A-4D depicts example frontend interfaces including a recommendation region having selectable recommendation objects.

FIGS. 5A-5B depict example frontend interfaces including recommended supplemental content.

FIGS. 6A-6B depict example frontend interfaces including recommended supplemental content.

FIG. 7A depicts a simplified diagram of a system, such as described herein that can include and/or may receive input from a generative output engine.

FIG. 7B depicts a functional system diagram of a system that can be used to implement a multiplatform prompt management service.

FIG. 8A depicts a simplified system diagram and data processing pipeline.

FIG. 8B depicts a system providing multiplatform prompt management as a service.

FIG. 9 shows a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

In general, content collaboration platforms enable system users to develop highly specialized content related to technical aspects of a project or product. As described herein, content collaboration platforms may include documentation platforms, issue tracking platforms, codebase development and management platforms, project management platforms, and other specialized platforms designed to handle a particular aspect of product development. Content collaboration platforms may include a high-degree of configurability and can be adapted for a wide range of products and other enterprise tasks. However, highly adaptive systems that provide each user or team with the ability to tailor content may also result in content creation that varies in quality and form depending on the content creator. Additionally, some system users may not be well versed in all of the functionalities a flexible and configurable platform may offer. Specifically, platforms that include a rich text editor that provides a large number of editors-specific objects or formatting options may be underutilized by an untrained or occasional user. Further, user-specific preferences or content-creation styles may vary, which may impede efficient electronic communication and electronic documentation.

The systems and techniques described herein are directed to a system that can be automatically deployed within a content collaboration platform in order to systematically suggest and/or modify electronic content items in order to enhance content quality and consistency across the platform. Specifically, the systems and techniques described herein are directed to automated content classification and analysis operations that can be used to present in-context generative content recommendations within a content-creation user interface. These systems and techniques may deploy a consistent set of system-generated content snippets and platform objects that maintain the original substance of the content item while improving quality and consistency of the content items. The systems and techniques described herein may also be used to provide recommended supplemental content based on an evaluation or analysis of user-generated content. As described herein, an evaluation or analysis of user-generated content may indicate a missing content component or elements and, as a result, may generate recommended supplemental content that may be adopted and automatically inserted into the user-generated content.

The systems and techniques described herein may review the content and provide or recommend supplemental content that may be required or recommended for a particular content item before it is published or released for use within the system. As described herein, a content item may be analyzed in order to identify missing titles, tables of content, executive summaries, platform-specific objects, or other content elements that are required or suggested in order to conform with platform policies and required functionality. In order to generate this supplemental content, the system may be adapted to extract respective content from related existing content items within the same user group or document space to help the generated content maintain a more uniform quality and appearance within the existing electronic content.

Embodiments described herein are directed to automatic content generation for a user-generated content item including, for example, electronic documents or pages, issues or work items, entity profiles or other electronic user-generated content. Some examples described herein are directed to systems and techniques for analyzing user-generated content of a content item and, in response to a trigger condition, such as a content publication operation, evaluate a content condition with respect to a content or sufficiency criteria. In response to the analysis indicating that there is a missing document component or element, the system may generate a prompt that is provided to a model or generative output engine, which produces a generative response. Based on the generative response, the system may cause generation and display of a recommended supplemental content that is predicted to correspond to the missing document component or element. The user may adopt the recommendation, which is automatically added to the existing user-generated content. In some cases, the system evaluates similar content in the same document space or related to the same author in order to adapt the generated recommendation for a user's style or formatting preferences. In some cases, attributes of the user's profile, such as a role, or other context may also be used to adapt the generated recommendation. As described herein, the recommended supplemental content may include a content title, table of contents, content overview, content summary, or other supplemental content.

In some implementations, the missing component or element is required before a particular action can be performed. For example, in some implementations a document or page title must be defined before the content can be published or shared. This may be required as the document title is used to generate navigational elements or other system identifiers, which can be used to access published or shared content. In this example, the publication or share operation may be momentarily suppressed, suspended, or paused while the recommended supplemental content is generated and rendered for the user. Upon selection of the recommendation, the publication or share operations may be resumed. As described herein, the system may be adapted to define a title that is unique within a particular document space to allow the text to be used as a unique content identifier. In some cases, the user may also edit or adapt the system-generated recommendation before adopting or causing insertion of the generated content.

Embodiments described herein also relate to systems, devices, and methods for content generation to improve or modify existing user-generated content of a content item. These systems and techniques may be used for content generation including generated recommendations for nodes or content segments of a content item, such as an electronic document or page. In particular, a generative service or system may be used to classify content nodes or segments of the document content and prepare node-or segment-specific recommendations within the context of a document editor interface. Embodiments described herein are also directed to aspects of a graphical user interface that allows users to review the generated recommendations, visualize relationships between the recommendations and the current document content, preview narratives and generative content, and implement the recommendations directly within the current electronic document or page. A similar technique may also be used for non-required or preferred content, such as a table-of-contents, content overview, content summary, or other recommended content that the system detects may be missing from the user-generated content.

Each type of node or document segment may be analyzed in order to determine a class of suggested action or recommendation. Based on the analysis of a particular node or document a respective recommendation engine may be selected, which may be adapted for processing the respective class of the suggested action or recommendation. Each recommendation engine may be configured to produce particular content, which may be generated with a particular editor-specific format or include editor-specific objects. For example, some of the recommendation engines described herein may produce a narrative or natural language output that may be generated based on a node or content segment of the document. Other recommendation engines may generate a table, matrix, or other type of structured content that is generated based on a different class of node or content segment. Still other recommendation engines may generate a content panel or other graphical elements including a short summary, topic description, or document take away based on another glass of node or content segment. The same or similar techniques may be used to generate supplemental content, that may be identified as missing from existing user-generated content.

The systems and techniques described herein may generate recommendation objects and recommended supplemental content that have been generated using a respective recommendation engine or generation module. As described herein, some of the recommendation engines or generation modules may use or access a large language model or other type of generative engine in order to automatically synthesize or generate new content. As described in more detail below, respective engines or modules may be adapted to construct prompts or other data elements that can be provided to a generative engine which, in turn, produces a generative response, which may be leveraged by the system to produce particular recommendation objects, supplemental content, or other content for the platform.

Generally, automatically generated content can supplement, summarize, format, and/or structure existing tenant-owned user-generated content created by a user while operating a software platform, such as described herein. In one embodiment, user-generated content can be supplemented by an automatically generated summary. The generated summary may be prepended to the content such that when the content is rendered for other users, the summary appears first. In other cases, the summary may be appended to an end of the document. In yet other examples, the generated summary may be transmitted to another application, messaging system, or notification system. For example, a generated document summary can be attached to an email, a notification, a chat or ITSM support message, or the like, in lieu of being attached or associated with the content it summarizes.

In another example, user-generated content can be supplemented by automatic insertion of format markers or style classes (e.g., markdown tags, CSS classes, and the like) into the user-generated content itself. In other examples, user-generated content can be rewritten and/or restructured to include more detail, remove unnecessary detail, and/or adopt a more neutral or positive tone. These examples are not exhaustive.

In yet other examples, multiple disparate user-generated content items, stored in different systems or in different locations, can be collapsed together into a single summary or list of summaries.

In addition to embodiments in which automatically generated content is generated in respect of existing user-generated content (and/or appended thereto), automatically generated content as described herein can also be used to supplement API requests and/or responses generated within a multiplatform collaboration environment. For example, in some embodiments, API request bodies can be generated automatically by leveraging systems described herein. The API request bodies can be appended to an API request provided as input to any suitable API of any suitable system. In many cases, an API with a generated body can include user-specific, API-specific, and/or tenant-specific authentication tokens that can be presented to the API for authentication and authorization purposes.

The request bodies, in these embodiments, can be structured so as to elicit particular responses from one or more software platforms'API endpoints. For example, a documentation platform may include an API endpoint that causes the documentation platform to create a new document from a specified template. Specifically, in these examples, a request to this endpoint can be generated, in whole or in part, automatically. In other cases, an API request body can be modified or supplemented by automatically generated output, as described herein.

For example, an issue tracking system may present an API endpoint that causes creation of new issues in a particular project. In this example, string or other typed data such as a new issue titles, new issue state, new issue description, and/or new issue assignee fields can be automatically generated and inserted into appropriate fields of a JSON-formatted request body. Submitting the request, as modified/supplemented by automatically generated content, to the API endpoint can result in creation of an appropriate number of new issues.

In another example, a trouble ticket system (e.g., an information technology service management or “ITSM” system) may include an interface for a service agent to chat with or exchange information with a customer experiencing a problem. In some cases, automatically generated content can be displayed to the customer, whereas in other cases, automatically generated content can be displayed to the service agent.

For example, in the first case, automatically generated content can summarize and/or link to one or more documents that outline troubleshooting steps for common problems. In these examples, the customer experiencing an issue can receive through the chat interface, one or more suggestions that (1) summarize steps outlined in comprehensive documentation, (2) link to a relevant portion of comprehensive documentation, or (3) prompt the customer to provide more information. In the second case, a service agent can be assisted by automatically generated content that (1) summarizes steps outlined in comprehensive documentation and/or one or more internal documentation tools or platforms, (2) link to relevant portions of comprehensive help documentation, or (3) prompt the service agent to request more information from the customer. In some cases, generated content can include questions that may help to further narrowly characterize the customer's problem. More generally, automatically generated content can assist either or both service agents and customers in ITSM environments.

The foregoing embodiments are not exhaustive of the manners by which automatically generated content can be used in multi-platform computing environments, such as those that include more than one collaboration tool.

More generally and broadly, embodiments described herein include systems configured to automatically generate content within environments defined by software platforms. The content can be directly consumed by users of those software platforms or indirectly consumed by users of those software platforms (e.g., formatting of existing content, causing existing systems to perform particular tasks or sequences of tasks, orchestrate complex requests to aggregate information across multiple documents or platforms, and so on) or can integrate two or more software platforms together (e.g., reformatting or recasting user generated content from one platform into a form or format suitable for input to another platform).

### Scalable Network Architecture for Automatic Content Generation

More specifically, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input. Many of the examples described herein are directed to an interface that includes a generative interface panel having an input region that can receive commands, references to content, links, and other input, at least a portion of which is provided as natural language text.

In some examples, the user may engage with a button in a UI that causes the generative interface panel or a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands-after the user types a slash character, any text input after the slash character can be considered as a command to instruct the underlying system to perform a task.

Regardless of how a software platform user interface is instrumented to receive user input, the user may provide an input that includes a string of text including a natural language request or instruction (e.g., a prompt). The prompt may be provided as input to an input queue including other requests from other users or other software platforms. Once the prompt is popped from the queue, it may be normalized and/or preconditioned by a preconditioning service. The preconditioning service may be provided by one or more registered plugins that are selected in accordance with an analysis of the input and/or context of the current session.

The preconditioning service can, without limitation: append additional context to the user's raw input; may insert the user's raw input into a template prompt selected from a set of prompts (also referred to herein as “predetermined query prompt text” or “predetermined prompt text”); replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### Large Language Models

An example of a generative output engine of a generative output system as described herein may be a large language model (LLM). An LLM may include a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the Like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phrase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. An LLM is typically trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation can be selected or generated using a number of techniques. In many cases, a continuation of an input prompt may be referred to more generally as “generated text” or “generated output” provided by a generative output engine as described herein.

Fundamentally all written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation. In addition, because punctuation and whitespace can serve as a portion of training data, generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt. For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href='https://example link/123456 123456</a>”. In addition, the LLM may be configured to replace the substring “pending” with a real-time updating token associated with an API call to the project management system. In this manner, the LLM converts a static string within the document management system into richer content that facilitates convenient and automatic cross-linking between software products, and may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilitates bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Transformer Architecture

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of attention mechanisms, including self-attention mechanisms, may be suitable.

In response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations. In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide an output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### Generative Output Engines & Generative Output Systems

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoint, such as for configuration or for receiving input prompts. The generative output application can be further configured to provide generated text output to one or more subscribers or API clients. Many suitable interfaces can be configured to provide input to and receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:
{
   “prompt”:“Generate five words of placeholder text in the English language.”,
   “API_KEY”:“hx-Y5u4zx3kaF67AzkXK1hC”,
   “user_token”:“PkcLe7Co2G-50AoIVojGJ”
}

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:
{
   “response”:“Hello world text goes here.”,
   “generation_time_ms”:2
}

In some embodiments, a prompt provided as input to a generative output engine can be engineered from user input. For example, in some cases, a user input can be inserted into an engineered template prompt that itself is stored in a database and includes text that may be referred to as predetermined query prompt text or predetermined prompt text. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### Prompt Pre-Configuration, Templatizing, & Engineering

As noted above, a prompt received from a user can be preconditioned and/or parsed to extract certain content therefrom. The extracted content can be used to inform selection of a particular engineered prompt template from a database of engineered prompt templates including predetermined query prompt text or predetermined prompt text. Once the selected prompt template is selected, the extracted content can be inserted into the template to generate a populated engineered prompt template that, in turn, can be provided as input to a generative output engine as described herein. Content extraction, prompt configuration, and prompt selection may be performed by a processing plugin that is registered or otherwise available to a generative service.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance,” “prompt preconditioning software instance,” “processing plugin,” or “plugin”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences.

For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on. For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:
{
   “raw_prompt”:“summarize the edits to this page made by my team since I last visited this page”,
   “modified_prompt”:“Generate a summary of each paragraph tagged with an editId attribute matching editId=1, editId=51, editId=165, editId=99 within the following HTML-formatted content: [HTML-formatted content of the page].”
}

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:
{
   “snippet123_table_from_tasks”:“The table should be formatted as a three-column table with multiple rows. The leftmost column should be titled ‘Title’ and the corresponding content of each row of this column should be the title attribute of a task. The middle column should be titled ‘Created Date’ and the corresponding content of each row of this column should be the creation date of the task. The rightmost column should be titled ‘Status’ and the corresponding content of each row of this column should be the status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:
{
   “modified_prompt”:“Find all tasks assigned to User 1234 dating from Jan. 1, 2023-Jan. 14, 2023 (inclusive). Create a table in which each found task corresponds to a respective row of that table. The table should be formatted as a markdown table, in plain text, with three columns. The leftmost column should be titled ‘Title’ and the corresponding content of each row of this column should be the title attribute of a respective task. The middle column should be titled ‘Created Date’ and the corresponding content of each row of this column should be the creation date of the respective task. The rightmost column should be titled ‘Status’ and the corresponding content of each row of this column should be the status attribute of the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents.

In yet other examples, staging of requests may be useful for other purposes.

### Authentication & Authorization

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each page or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url”.

In yet other examples, a prompt engineering service may be configured to classify a user input into one of a number of classes of request. Different classes of request may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein. More generally, as noted above, a generative output engine may be a portion of a larger network and communications architecture as described herein. This network can include input queues, prompt constructors, engine selection logical elements, request routing appliances, authentication handlers and so on.

### Collaboration Platforms Integrated With Generative Output Systems

In particular, embodiments described herein are focused to leveraging generative output engines to produce content in a software platform used for collaboration between multiple users, such as documentation tools, issue tracking systems, project management systems, information technology service management systems, ticketing systems, repository systems, telecommunications systems, messaging systems, and the like, each of which may define different environments in which content can be generated by users of those systems. For example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine, as described herein, in order to automatically generate structured or unstructured content within environments defined by those systems. For example, a documentation system can leverage a generative output engine to, without limitation: summarize individual documents; summarize portions of documents; summarize multiple selected documents; generate document templates; generate document section templates; generate suggestions for cross-links to other documents or platforms; generate suggestions for adding detail or improving conciseness for particular document sections; and so on.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multitenant software platform.

For simplicity of description, the multitenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform—multitenant or otherwise—as described herein are not collocated, and communicate over a large area and/or wide area network by leveraging one or more networking protocols, but this is not required of all implementations.

A frontend of a software platform as described herein may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multitenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third-party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multitenant software and, in particular, by a provider of suites of multitenant software platforms, each platform being configured for a different particular purpose. Herein, providers of systems or suites of multitenant software platforms are referred to as “multiplatform service providers.” Generally, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multitenant issue tracking system, a multitenant code repository service, and a multitenant documentation service. In this example, an organization that is a customer/client of the service provider may be a tenant of each of the issue tracking system, the code repository service, and the documentation service.

As with preceding examples, the organization can create and/or purchase user accounts for its employees, so that certain selected employees have access to one or more of issue tracking functionality, documentation functionality, and code repository functionality.

In this example and others, a system may leverage multiple collaboration tools to advance individual projects or goals. For example, for a single software development project, a software development team may use (1) a code repository to store project code, executables, and/or static assets, (2) a documentation service to maintain documentation related to the software development project, (3) an issue tracking system to track assignment and progression of work, and (4) a messaging service to exchange information directly between team members.

However, as organizations grow, as project teams become larger, and/or as software platforms mature and add features or adjust user interaction paradigms over time, using multiple software platforms can become inefficient for both individuals and organizations. To counteract these effects, many organizations define internal policies that employees are required to follow to maintain data freshness across the various platforms used by an organization.

For example, when a developer submits a new pull request to a repository service, that developer may also be required by the organization to (1) update a description of the pull request in a documentation service, (2) change a project status in a project management application, and/or (3) close a ticket in a ticketing or issue tracking system relating to the pull request. In many cases, updating and interacting with multiple platforms on a regular and repeating basis is both frustrating and time consuming for both individuals and organizations, especially if the completion of work of one user is dependent upon completion of work of another user.

Some solutions to these and related problems often introduce further issues and complexity. For example, many software platforms include an in-built automation engine that can expedite performance of work within that software platform. In many cases, however, users of a software platform with an in-built automation engine may not be familiar with the features of the automation engine, nor may those users understand how to access, much less efficiently utilize, that automation engine. For example, in many cases, accessing in-built automation engines of a software platform requires diving deep into a settings or options menu, which may be difficult to find.

Other solutions involve an inter-platform bridge software that allows data from one platform to be accessed by another platform. Typically, such bridging software is referred to as an “integration” between platforms. An integration between different platforms may allow content, features, and/or functionality of one platform to be used in another platform.

For example, a multiplatform service provider may host an issue tracking system and a documentation system. The provider may also supply an integration that allows issue tracking information and data objects to be shown, accessed, and/or displayed from within the documentation system. In this example, the integration itself needs to be separately maintained in order to be compliant with an organization's data sharing and/or permissions policies. More specifically, an integration must ensure that authenticated users of the documentation system that view a page that references information stored by the issue tracking system are also authorized to view that information by the issue tracking system.

Phrased in a more general way, an architecture that includes one or more integrations between tenancies of different software platforms requires multiple permissions requests that may be forwarded to different systems, each of which may exhibit different latencies, and have different response formats, and so on. More broadly, some system architectures with integrations between software platforms necessarily require numerous network calls and requests, occupying bandwidth and computational resources at both software platforms and at the integration itself, to simply share and request information and service requests for information by and between the different software platforms. This architectural complexity necessitates careful management to prevent inadvertent information disclosure.

Furthermore, the foregoing problem(s) with maintaining integrations' compliance with an organization's policies and organization-owned content access policies may be exacerbated as a provider's platform suite grows. For example, a provider that maintains three separate platforms may choose to provide three separate integrations interconnecting all three platforms. (e.g., 3 choose 2). In this example, the provider is also tasked with maintaining policy compliance associated with those three platforms and three integrations. If the provider on-boards yet another platform, a total of six integrations may be required (e.g., 4 choose 2). If the provider on-boards a fifth platform, a total of ten integrations may be required (e.g., 5 choose 2). Generally, difficulties of maintaining integrations between different software platforms (in a permissions policy compliant manner) scales exponentially with the number of platforms provided.

Further to the inadvertent disclosure risk and maintenance obligations associated with inter-platform integrations, each integration is still only configured for information sharing, and not automation of tasks. Although context switching to copy data between two integrated platforms may be reduced, the quantity of tasks required of individual users may not be substantially reduced.

Further solutions involve creating and deploying dedicated automation platforms that may be configured to operate with one, and/or perform automations of, or more platforms of a multiplatform system. These, however, much like automation engines in-built to individual platforms, may be difficult to use, access, or understand. Similarly, much like integrations described above, dedicated automation platforms require separate maintenance and employee training, in addition to licensing costs and physical or virtual infrastructure allocations to support the automation platform(s).

In still further other circumstances, many automations may take longer for a user to create than the time saved by automating that particular task. In these examples, individual users may avoid defining automations altogether, despite that, in aggregate, automation of a given task may save an organization substantial time and cost.

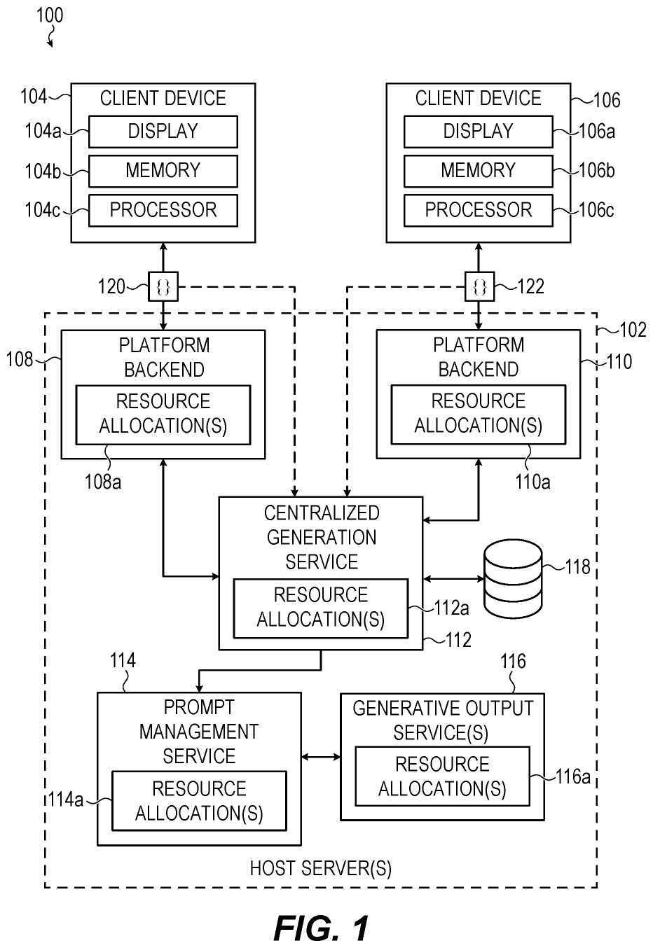

These foregoing and other embodiments are discussed below with reference to FIGS. 1-9. However, the detailed description given herein with respect to these figures is for explanation only and should not be construed as limiting.

FIG. 1 depicts system diagram that includes multiple platforms that can include and/or may receive input from a generative output engine, as described herein. The system 100 can be used to produce generative responses, which may include recommended objects, recommended supplemental content, summaries and/or brief descriptions of content items, as described herein. The system 100 of FIG. 1 depicts an example of how multiple platforms 108, 110 may utilize a centralized summary generation service 112 (also referred to as a centralized content generation service 112), which may produce the summaries or brief descriptions or other generative content using a generative output engine of a generative output service 116.

The system 100 is depicted as implemented in a client-server architecture, but it may be appreciated that this is merely one example and that other communications architectures are possible. In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can support infrastructure for one or more backend applications, each of which may be associated with a particular software platform, such as a documentation platform or an issue tracking platform. Other examples include information technology system management (ITSM) systems, chat platforms, messaging platforms, and the like. These backends can be communicably coupled to a generative output engine that can be leveraged to provide unique intelligent functionality to each respective backend. For example, the generative output engine can be configured to receive user prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system as well.

A user of the client devices may trigger production of generative output in a number of suitable ways. The examples described herein include the triggering of a centralized summary generation service 112 (also referred to as a generative service or generative system) in response to a synchronous or scheduled processing of a set of content items that satisfy a content criteria. The generation service 112 may also be triggered in response to user input provided to a frontend application corresponding to a respective one of the platform backends 108, 110. A variety of implementations and examples are described in the following figures.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110. The two different platforms maybe instantiated over physical resources provided by the set of host servers 102. Once instantiated, the first platform backend 108 and the second platform backend 110 can each communicably couple to a centralized summary generation service 112.

The centralized summary generation service 112 can be configured to cause generation and display of generative content within respective frontends of each of the first platform backend 108 and the second platform backend 110. In this manner, and as a result of this construction, each of the first platform and the second platform can be provided with a consistent or uniform user experience with respect to the generation of generative content.

More specifically, the centralized summary generation service 112 may provide a mechanism to request and obtain summaries of content through selectable graphical objects and other elements from various platforms in the multiplatform environment, and communicate with the generative output engine to fulfill the summary requests and provide responses from the generative output engine back within the selectable graphical objects. As a result of this centralized architecture, multiple platforms in a multiplatform environment can leverage the features of the generative output engine via the selectable graphical object, regardless of the platform of the system 100 in which the selectable graphical object resides. This provides a consistent experience to users across platforms while simplifying processes of updating or otherwise modifying the service to the generative output engine.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized summary generation service 112 that can be called by each respective frontend whenever it is required to present the user of that respective frontend with an interface to edit text.

For example, the documentation platform's frontend or the issue tracking platform's fronted may call upon the centralized summary generation service 112 to interact with a generative output engine to obtain and provide a generative content in accordance with a scheduled or synchronous processing of a set of content items. The generation service 112 may also be utilized to summarize or process target content referenced by a selectable graphical object when a user of the documentation platform or issue tracking platform requests the summary via a button or other input of the selectable graphical object.

Similarly, the documentation platform's frontend or the issue tracking platform's frontend may call upon the centralized summary generation service 112 to interact with a generative output engine to obtain and provide a response to a question or query regarding the target content referenced by a selectable graphical object when a user of the documentation platform provides a question or query regarding the target content via an input of the selectable graphical object.

In these examples, the centralized summary generation service 112 can parse text input provided by users of the documentation platform and/or the issue tracking platform, monitoring for summary request inputs or questions provided via selectable graphical objects. In addition, as a result of the architectures described herein, services supporting the centralized summary generation service 112 can be extended to include additional features and functionality that can automatically be leveraged by any further platform that incorporates selectable graphical objects, and/or otherwise integrates with the centralized summary generation service 112 itself.

The generative output engine service may be hosted over the host servers 102 or, in other cases, may be a software instance instantiated over separate hardware. In some cases, the generative engine service may be a third party service that serves an API interface to which one or more of the host services and/or preconditioning service can communicably couple. The generative output engine can be configured as described above to provide any suitable output, in any suitable form or format. Examples include content to be added to user-generated content, API request bodies, replacing user-generated content, and so on.

More generally and broadly, the embodiments described herein refence systems and methods for generating a summary of target content within selectable graphical objects sharing user interface elements rendered by a centralized summary generation service 112 and features thereof, between different software platforms in an authenticated and secure manner.

The first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized summary generation service 112. Information can be transacted by and between the frontend, the first platform backend 108 and the centralized summary generation service 112 in any suitable manner or form or format. In many embodiments, as noted above, the client device 104 and in particular the first platform frontend can be configured to send an authentication token 120 along with each request transmitted to any of the first platform backend 108 or the centralized summary generation service 112 or the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client devices resources 106a-106c, respectively.

As with many embodiments described herein, the second platform frontend can be configured to communicate with the second platform backend 110 and/or the centralized summary generation service 112. Information can be transacted by and between the frontend, the second platform backend 110 and the centralized summary generation service 112 in any suitable manner or form or format. In many embodiments, as noted above, the client device 106 and in particular the second platform frontend can be configured to send an authentication token 122 along with each request transmitted to any of the second platform backend 110 or the centralized summary generation service 112.

As a result of these constructions, the centralized summary generation service 112 can provide uniform feature sets to users of either the client device 104 or the client device 106. As noted above, the centralized summary generation service 112 ensures that common features are available to frontends of different platforms. One such class of features provided by the centralized summary generation service 112 invokes output of a generative output engine of a service such as the generative output service 116. For example, as noted above, the generative output service 116 can be used to generate content, supplement content, and/or generate API requests or API request bodies that cause one or both of the first platform backend 108 or the second platform backend 110 to perform a task. In some cases, an API request generated at least in part by the generative output service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized summary generation service 112. The user input may include a prompt to be continued by the generative output service 116.

The prompt management service 114 can be configured to modify the user input, to supplement the user input, select a prompt from a database (e.g., the database 118) based on the user input, insert the user input into a template prompt, replace words within the user input, preform searches of databases (such as user graphs, team graphs, and so on) of either the first platform backend 108 or the second platform backend 110, change grammar or spelling of the user input, change a language of the user input, and so on. The prompt management service 114 may also be referred to herein as herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized summary generation service 112 to return to a suitable backend application, to in turn return to or perform a task for the benefit of a client device such as the client device 104 or the client device 106. More particularly, it may be appreciate that although FIG. 1 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized summary generation service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may include a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative output service 116.

Suggestions rendered in a UI can also include and/or may be associated with one or more configurable or “templatized prompts” that are engineered with one or more fields that can be populated with data or information before being provided as input to an LLM. A templatized prompt may include static language that may also be referred to as “predetermined query prompt text” and may be combined with current context or content in order to construct or generate a prompt. An example of a templatized prompt may be “summarize all tasks assigned to ${user} with a due date in the next 2 days.” In this example, the token/field/variable ${user} can be replaced with a user identifier corresponding to the user currently operating a client device.

This insertion of an unambiguous user identifier can be preformed by the client device, the platform backend, the centralized summary generation service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user123 with a due date in the next 2 days” can be retrieved from a database or other memory, and provided as input to the generative output service 116.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “${user prompt} provide output of any table in the form of a tab delimited table formatted according to the markdown specification.” In this example, the variable ${user prompt} may be replaced with the user prompt such that the entire prompt received by the generative output service 116 can include the user prompt and the example sentence describing how a table should be formatted.

In yet other embodiments, a suggestion may be generated by the generative output service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative output service 116 may generate a set of JSON objects that, when received by the Kanban platform, are rendered as a set of cards in a Kanban board, each card including a different title and description corresponding to different tasks that may be associated with steps for creating a new ice cream flavor. In this manner, the user can quickly be presented with an example set of initial tasks for a new project.

In yet other examples, suggestions can be configured to select or modify prompts that cause the generative output service 116 to interact with multiple systems. For example, a suggestion in a documentation system may be to create a new document content section that summarizes a history of agent interactions in an ITSM system. In some cases, the generative output service 116 can be called more than once and/or it may be configured to generate its own follow-up prompts or prompt templates which can be populated with appropriate information and re-submitted to the generative output service 116 to obtain further generative output. More simply, in some embodiments, generative output may be recursive, iterative, or otherwise multi-step in some embodiments.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a.

Similarly, the second platform backend 110 may be instantiated over the resource allocations 110a (including processors, memory, storage, network communications systems, and so on). Likewise, the centralized summary generation service 112 is supported by a processor and memory and network connection (and/or database connections) collectively represented for simplicity as the resource allocations 112a.

The prompt management service 114 can be supported by its own resources including processors, memory, network connections, displays (optionally), and the like represented in the figure as the resource allocations 114a. In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized summary generation service 112. As further described herein, the system 100 supports content summary generation within a content collaboration system. In one or more embodiments, as further described herein, the system 100 utilizes selectable graphical objects or other elements within a graphical user interface (GUI) that is displayed at a client device. The selectable graphical objects or other elements may contain a portion of content obtained from target content, and other selectable elements and graphics including, for example a title, author or content creating user, or other content. A user may be provided, via the GUI, with an input to use to request a summary of the target content. The request may be provided via a designated user input like a cursor hover input or may be a selection of a selectable control (e.g., a button). The system, for example by the centralized summary generation service 112, may generate a prompt and provide to the generative output engine (e.g., via the generative output service 116) that prepares and outputs a generative response. The generative response may include a textual, natural language summary. The summary may be, for example, a textual summary of a page, set of messages, list of actions, key decisions, or items and summaries related to the target content. Subsequent processing of the summary may include identifying textual portions associated with system-specific items, and populating the summary with system-specific mentions, links, tables, video, audio, and so on. In some cases, the system-specific mentions are populated based on permissions that are specific to the user.

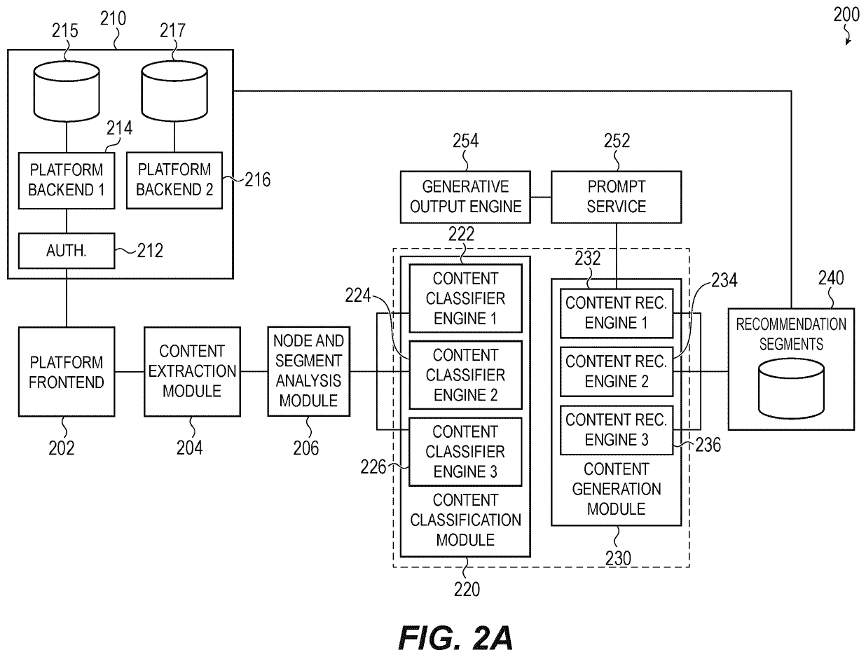

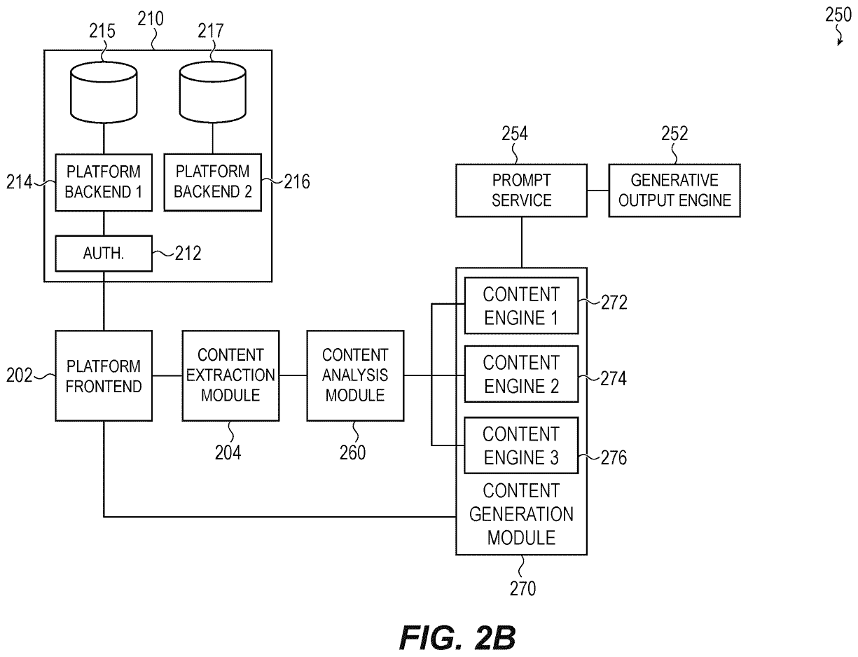

Further, as described herein and more specifically with respect to the system of FIGS. 2A and 2B, below, the system may utilize the centralized summary generation service 112 in order to evaluate or analyze user-generated content and generate recommended objects, recommendation segments, recommended supplemental content and other content for use in an editor or content region of a content collaboration platform. The centralized summary generation service 112 may be utilized for access to a generative output engine, for generating or preconditioning prompts, and/or performing post-processing on generative responses received from the generative output engine.

FIG. 2A depicts an example system and process flow for generating recommended objects and/or supplemental content. Specifically, FIG. 2A depicts an example system 200 that includes various process modules or operations that may be implemented using hardware and networked computer components described herein. While each of the modules or processes may be described with respect to a particular software implementation, the system 200 includes the use of hardware elements including networked electronic devices, such as servers, client devices, and backend components described elsewhere in this description. A description of the hardware is not repeated with respect to FIG. 2A to reduce redundancy and improve clarity.

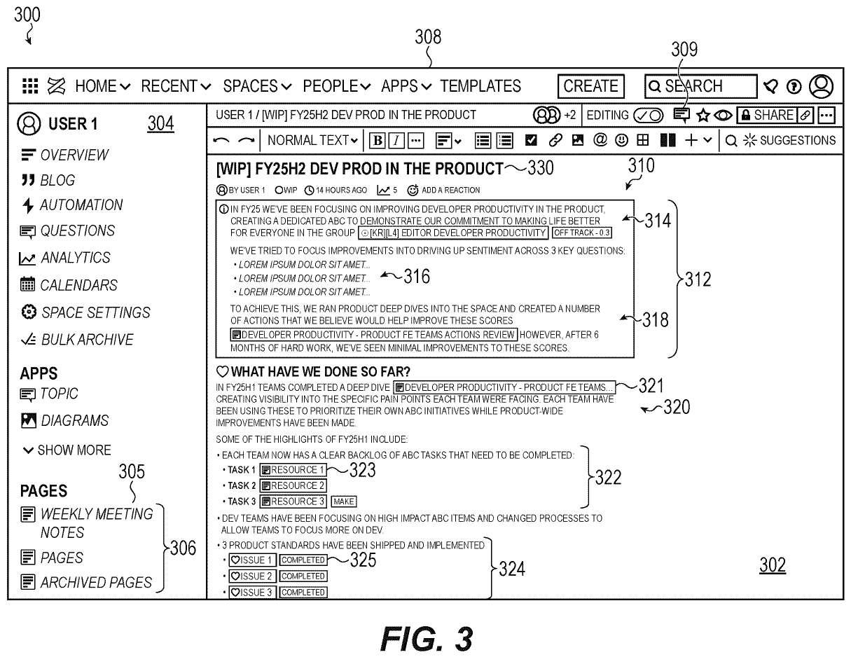

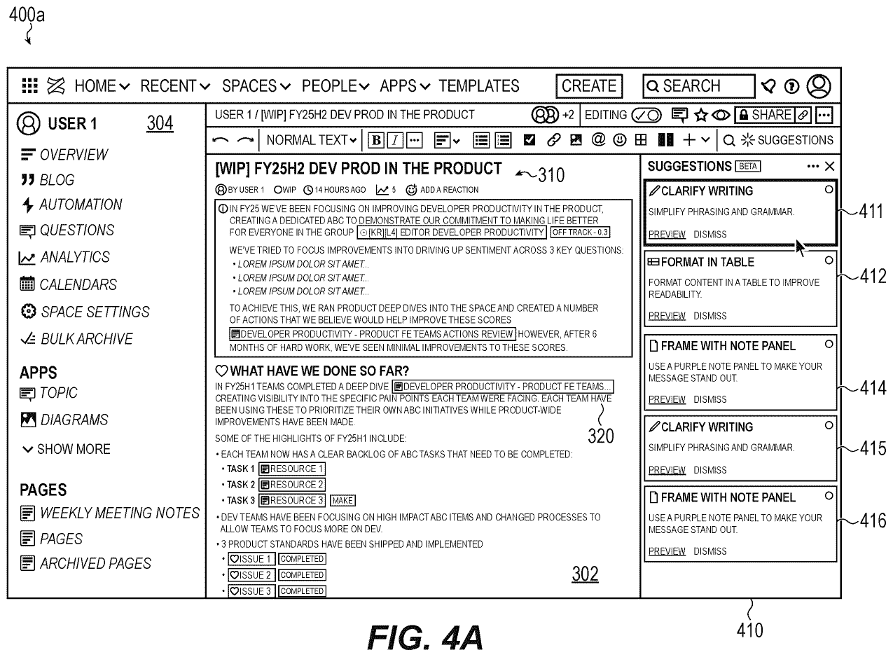

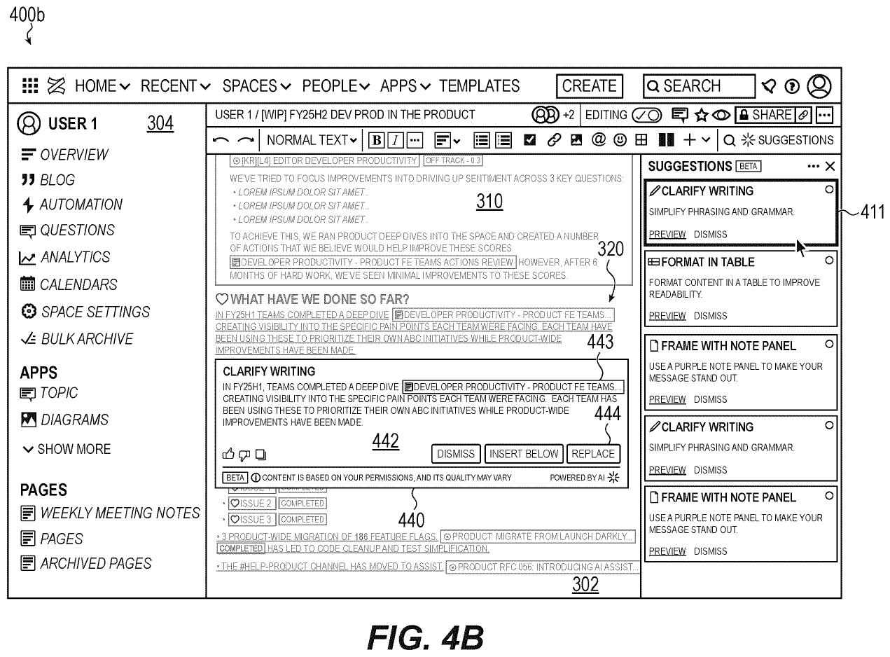

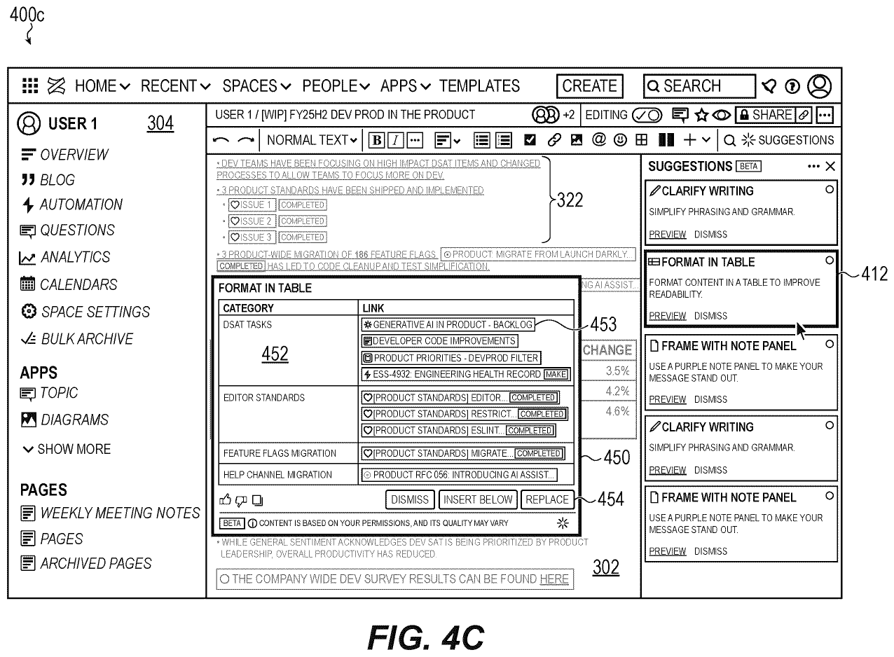

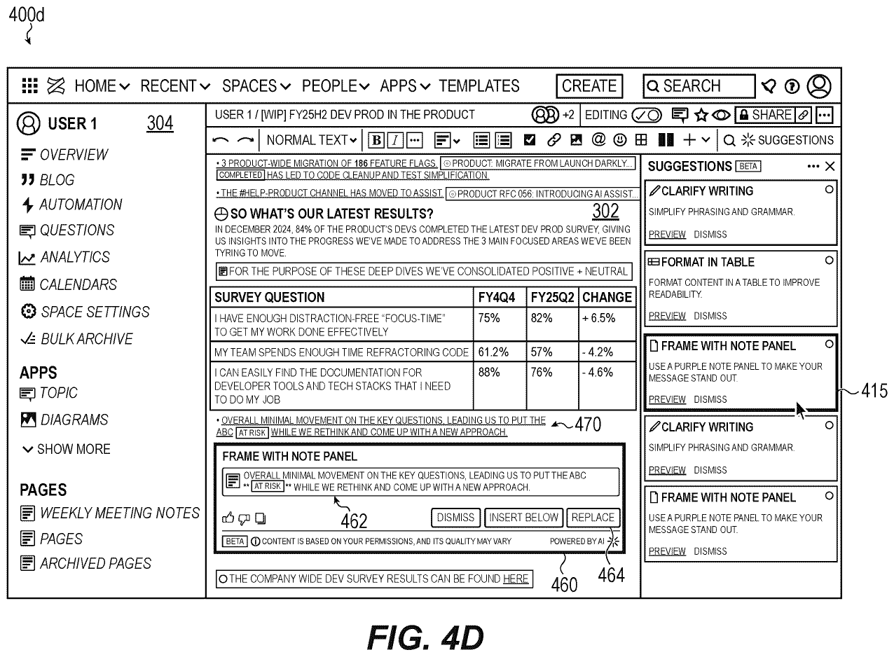

FIG. 2A depicts a system 200 that can be used to generate recommended content and supplemental content for a current content item being viewed or edited by an authenticated user. As discussed previously, the system may generate and display recommended or supplemental content to the user, which may be used to modify or edit a current content item. The recommended content may be displayed as selectable recommended objects or items within a recommendation region or panel of the graphical user interface in order to provide the recommendations within the current context of the platform. Additionally, as described in more detail below with respect to FIGS. 3-4D, the selectable recommended objects may, in response to user input, be used to provide mappings between the recommendations and the original content, preview recommendation content, and/or modify or replace original content using the recommendation content.

In the example system 200, the user accesses the system using a platform frontend application, which may be operating on the hardware of the client device, also referred to as platform frontend 202. The platform application of the platform frontend 202 may include a browser or other web-enabled application that is adapted for use with a web-based platform backend or other similar service over a computer network like the web or internet. In other examples, the platform application of the platform frontend 202 is a dedicated client application that is adapted to communicate with a dedicated backend or other server system via a computer network. The example system 200 includes platform backends 214, 216, which may be either web-based servers or dedicated backend servers, depending on the implementation. The frontend application of the platform frontend 202 provides a graphical user interface for the platform, which may include content creation interfaces, content viewing interfaces, and other interfaces for interacting with the content and features of the platform backend. Example graphical user interfaces are described in more detail below with respect to FIGS. 3-4D and 5A-6B.

The platform backends 214, 216 (also referred to as backend applications operating on one or more servers or similar hardware) provide the platform functionality and access to respective content stores 215, 217. Together, the platform backends 214, 216 may form part of a federated application service or system 210. The federated system 210 may leverage a common authentication service 212, shared or linked user accounts, and may exchange information using dedicated and/or integrated communication gateways. Each platform backend 214, 216 may provide the backend for a particular type of content collaboration platform.

Example content collaboration platforms include documentation platforms or systems, issue tracking platforms or systems, information technology service management (ITSM) platforms, project management platforms, scheduling platforms or systems, software development platforms, file sharing systems, video sharing platforms, video conferencing platforms, customer relation management systems, and the like. In general, content collaboration platforms (also referred to herein as “collaboration platforms” or “collaboration services”) can be used to generate, store, and organize user-generated content. As described herein, a collaboration platform or service may include an editor that is configured to receive user input and generate user-generated content that is saved as a content item. With respect to various examples provided herein, the term “collaboration platform” or “collaboration service” may be used to refer to a documentation platform or service configured to manage electronic documents or pages created by the system users, an issue tracking platform or service that is configured to manage or track issues or tickets in accordance with an issue or ticket workflow, a source-code management platform or service that is configured to manage source code and other aspects of a software product, a manufacturing resource planning platform or service configured to manage inventory, purchases, sales activity or other aspects of a company or enterprise. In some instances, the functionality described herein may be adapted to multiple platforms or adapted for cross-platform use, through the use of a common or unitary service, such as a summary generation service. For example, the functionality described in an example may be provided with respect to a particular collaboration platform, but the same or similar functionality can be extended to other platforms by using the same service. Also, as described above, a set of host services or platforms may be accessed through a common gateway or using a common authentication scheme, which may allow a user to transition between platforms and access platform-specific content without having to enter user credentials for each platform.

In one example, a user operating a platform frontend (also referred to as a platform application operating on a client device) is authenticated with respect to one or more of the platform backends 214, 216 using an authentication service or module 212. The authentication module 212 may authenticate a user using authentication credentials that include a username and password or other authentication credentials like an authentication token or other data issued by a coordinating or recognized authentication service. In some cases, the authentication module 212 may employ or utilize a single-sign-on (SSO) service, which may be leveraged across multiple platforms or applications. Authentication of the user ensures that the platform frontend is an authorized frontend and that the user has an active and valid account with the platform backend(s) 214, 216. Authentication is also used to associate user activity with a particular user account in order to manage content permissions and provide appropriate content creation attribution. User activity logs, user interaction logs, and other activity logs may also be associated with or tracked using the user account of the authenticated user.

Subsequent to a successful authentication, the platform frontend may cause display of a graphical user interface of the content collaboration platform. The graphical user interface may be a content creation interface in which the user can provide user-generated content for generating an electronic page or document, issue, source code, project content, or other type of content item hosted by the respective content collaboration platform. In the examples of FIGS. 3-4D and 5A-6B, the graphical user interface is a document or page editing interface that includes an editor configured to receive user-generated content. In some implementations, the user-generated content includes text, image, video, audio, and other formats and classes of user content. The text content may be structured rich text or encoded rich text content in which editor-specific or platform-specific objects or elements may be generated. In some implementations, the content may be formatted as a structured data representation which may be formatted using JSON, XML, or other schema or a custom syntax. The structured rich text may be adapted for programmatic manipulation provided by a particular editor or rendering engine. For example the rich content may include @mention objects, selectable graphical objects, embedded content, special characters, content regions, content panels, and other similar elements. As described herein, the recommendation generation system 200 may preserve some existing references or content and, in some cases, may generate new editor-or platform-specific objects.

The content recommendation or supplementation operations of system 200 may be initiated in response to, or subsequent to, a trigger condition being satisfied. The trigger condition may evaluate if a particular user interface event or action has occurred alone or in combination with timing criteria and other factors. Example events include a content save event, content publish event, or other user input event. Corresponding trigger conditions include a content save condition (e.g., a document or page save condition), a content publish condition (e.g., a document or page publish condition), or other user input provided to the platform frontend. In one example, the user input may be the entry of a threshold amount of content (e.g., a viewable page of content), a carriage return (e.g., signifying the end of a paragraph or block of text), or a selection of a control (e.g., a UI button or other element) that is associated with a request for content recommendations or an automated evaluation of the current content. In some implementations, the trigger condition includes the evaluation of an amount of time that the user has been generating content, an amount of time since the user has entered a last content item (e.g., indicating that the user may have completed the content item or a portion of the content item), or another evaluation of timing and/or system activity.

In response to or subsequent to the trigger condition being satisfied, the content extraction module 204 may extract content from the current content item (e.g., an electronic document or page) either directly from the platform frontend 202 or from the platform backend 214 or 216. In the case of the latter, the content extraction module 204 may formulate a query or call to the platform backend 214 or 216 which may include a content identifier and authentication token or other authenticating information. In other cases, the content extraction module 204 is integrated with one or more of the platform backends 214, 216 and may access content directly from a respective content store 215, 217, which may include a platform content monolith or other structured data storage. In addition to the explicit content, the module 204 may extract metadata including user-generation attribution, content creation date, document space data, linked or related content items (linked through a hierarchical document structure or page tree), and other metadata. The module 204 may also be adapted to access content for which links or references are present in the user-generated content. In one example, the user-generated content may include selectable graphical objects, as described herein, that include a panel, card, or other object that displays content extracted from a corresponding content item. The content item may be another content item of the current platform or an external content item hosted by a different or separate platform. As described elsewhere, selection of the selectable graphical object may cause redirection to the respective content item as rendered in an interface provided by the respective platform. The module 204 may, in some instances, leverage the credentials of the authenticated user in order to access content of the associated content item. If the content item is hosted by an external platform, the module 204 may access the content using an application programming interface or other similar data retrieval technique. The module 204 may extract metadata, content, or other data with respect to the linked or associated content item.

The module 204 may also collect current context including current or recently accessed content items, user profile data or user-preference settings, user-specific content samples or excerpts, user-group or project information, and other context information. In some cases, the module 204 may extract or access a content graph or knowledge graph that relates content items, user accounts, teams, projects, and other system elements using a respective edge or defined relationship. Data extracted from the content graph and the extracted context may be used to customize the recommendations and supplemental content for the particular user or present use case. This allows the recommendations to more closely resemble the user-generated content by the same user or other users that may be related to the user through interactions and content of the respective platform.

The content and other data obtained from the content extraction module 204 may then be processed by a node or segment analysis module 206. The module 206 may be adapted to generate or identify a set of content nodes (e.g., page or document content nodes) or content segments (e.g., document segments or page segments). Each of the content nodes or segments may be used to generate a respective recommendation object or item and presented to the user in the graphical user interface, as described below with respect to FIGS. 4A-4D.

In some implementations, the analysis module 206 may parse the extracted content and identify existing structural components defined by the structured rich text or encoded content, which may include tags or other marked text, text blocks, formatting objects or special objects like panels, frames, or other graphical elements, formatting elements, and other content. The parsed content may be stored as a structured data element like a JSON object or other similar schema. The content nodes or content segments may then be identified or defined based on the parsed content. In one example, a tokenization or other technique for grouping the content elements may be performed in order to identify text nodes or segments of related text, content sections or groupings, and other related elements of the content. The grouping operation may identify sections, paragraphs, text blocks, and other content groupings using a natural language processing technique that uses the grammatical structure, punctuation, content formatting, and other attributes of the content to define each of the content nodes or content segments. Each of the nodes or segments may then be related using a hierarchical definition to define parent-child relationships between the nodes or segments and store the nodes or segments as a structured object that defines both the nodes and the hierarchical relationships between them. Depending on the implementation, the recommendations may be performed for a particular level or set of level of nodes or segments in the hierarchy to avoid overlapping or potentially conflicting recommendations. In some cases, the recommendations may include an analysis of multiple levels of hierarchy, which may allow the user to select a level at which to deploy edits or modifications to the content. For example, recommendations provided for the most granular level nodes or child nodes may allow for improved sentence structure and grammatic phrasing. Recommendations provided for a higher-level node or set of nodes under a higher-level node may allow for improved thematic development or document structure. Providing both may allow the user to select which recommendations are appropriate for different portions of a document or content item.

In another example implementation, the set of content nodes may be defined using a generative output engine that includes or has access to a large-language model. For example, a prompt may be generated including predetermined query prompt text and the content extracted from the content item. The predetermined query prompt text may include instructions for node creation and example input-output pairs of original content and example nodes. The instructions may also include constraints including preferred node size or length, instructions for how to handle non-text content including content conversion or use of placeholder content. The predetermined query prompt text may also include instructions for how the output should be formatted in order to define the hierarchy and structure of the outputted nodes. Similar to other examples described herein, the prompt may be provided to a generative output engine using an application programming interface or other technique. In response, the generative output engine may produce a generative response, which includes generative content defining a set of nodes that are based on the extracted content. The generative content may be formatted as a structured data object like a JSON object or other structured object, which can be used to provide node definition, node content, and node hierarchy and other aspects of the set of nodes, as described herein.

In another example implementation, a set of rule sets and/or trained machine-learning models may be used to define one or more nodes of the set of nodes representing the content of the content item. In one example, the content is parsed using the set of rules and/or trained model(s) to identify blocks of text, related content, and other portions of content that may be defined as a node. The rule sets may evaluate the amount of text in a given block or group, the location of the block or group within the content item, and other properties of the block or group. The rule sets may also evaluate a given block or group with respect to a set of keywords or key phrases that may indicate that the content is to be defined as a node or segment.

In some implementations, the set of content nodes or content segments are preprocessed by the module 206 or another module in order to prepare the nodes or segments for classification and analysis. For example, in some cases, the content of the nodes may be converted into an embedded vector representation in which the words, characters or tokens of the nodes are represented numerically and embedding techniques may be used to expand or normalize the representation of the content. An embedded vector representation may be used for some of the operations, such as, for example the content classification module 220, while the words, characters or tokens may be preserved for use by other modules, such as, for example, the content generation module 230.

The preprocessing may also include analyzing the set of nodes to ensure that the nodes include a threshold amount of content, and that the node definitions satisfy other node criteria. Node criteria may include an analysis with respect to punctuation and/or grammar rules (e.g., a single paragraph ending in a period or other concluding punctuation). Node criteria may also be evaluated using a designated set of keywords or key phrases that are associated with a particular note type. Special formatting elements or structures, such as bulleted content, enumerated or listed content, and/or indentation or other formatting styles may also be used to analyze the nodes.

Node preprocessing may also include the identification of platform-specific or editor-specific content items that may be part of the structured rich text of the original content. As discussed previously, the structured rich text may be content that is adapted for programmatic manipulation provided by a particular editor or rendering engine. For example the rich content may include @mention objects, selectable graphical objects, embedded content, special characters, content regions, content panels, and other similar elements. In one example embodiment, rich text elements may be identified and replaced with a placeholder, which may include tags or otherwise designated characters that is inserted in-line with the content. Use of placeholder allows the rich text elements to be preserved while still allowing the content to be processed as normal or non-rich text. In some cases, a payload or value corresponding to the rich text may be included in the tagged or otherwise designated characters, which may be referenced by further modules when analyzing the content. Downstream modules or analysis elements may be instructed to preserve the placeholders and use the payload or values for analysis purposes. Preservation of the placeholders and payloads may allow for re-substitution of the original rich text elements in the processed or generated content and for the display of generated recommendations or supplemental content that appears similar in format and content to the original content item. By way of example, a text including the special character “@” followed by a handle (e.g., “@johndoe”) may correspond to a mention rich text element mention. The mention rich text element may allow a corresponding user to quickly identify content items in which their handle is included or referenced. Publication of content including mention rich text elements may also cause generation of notifications to the respective user or groups of users and may trigger other system operations. The preprocessing may identify mention rich text elements, along with other rich text elements and generate a placeholder including a designated character “</” used to include a placeholder identification and payload. Using the example above, the placeholder may include the text “</placeholder, mention, value=“johndoe”>”. The specific designated characters and format of the placeholder may vary depending on the implementation.

The content nodes or content segments may then be analyzed by the content classification module 220 in order to determine a content node type or content segment type for at least a subset of the content nodes or segments. The nodes or segments are classified in order to pair each of the classified nodes or segments with a respective content generation engine that is adapted to process similarly classified content. In particular, each content generation engine may include a trained machine learning model, generative engine, or other element that is adapted to produce recommendations for a particular type or class of content. Using content-type-specific recommendation models allows for more tailored recommendations and also allows the system to handle a broader range of content. Example content node types or content segment types include a narrative content type, which may correspond to text that that can be classified as a narrative (e.g., grammatical paragraph or set of sentences); a panel content type, which may correspond to content that can be represented as a topical or thematic sentence that relates to the theme or subject matter of the content item; a table content type, which may correspond to content that may be represented as a table or other structured format; or other content types.

In one example embodiment, the content classification module 220 includes a set of content classifier engines 222, 224, 226, each classifier engine adapted to process a respective class of content. Each content node or segment may be processed by each of the content classifier engines 222, 224, 226 to produce a set of analysis results that correspond to the respective content node or segment. The set of analysis results may be analyzed in order to define a content node type or content segment type, which may be used to select a corresponding content recommendation engine of the set of content recommendation engines 232, 234, 236. In one example implementation, the content recommendation engines 232, 234, 236 each produce a respective analysis result that includes a correlation metric, which may include a confidence score (e.g., confidence interval, confidence level), relevance score (e.g., relevance confidence), probability metric, or other measure of correlation between the content node or segment and the analysis result. The content node type or content segment type associated with a respective content classifier engine 222, 224, 226 having a correlation metric that satisfies a selection criteria may be associated with the particular content node or segment. For example, the content classifier engine 222, 22, or 226 having the highest correlation metric may be used to determine the content node type or content segment type. By way of example, the content node type or content segment type may include without limitation, a narrative content node type, a panel content node type or a table content node type.

In some implementations, the content classifier engines 222, 224, 226 are the same as the content recommendation engines 232, 324, 326 of the content generation module 230. In the current example system 200, separate content classifier and content generation modules are depicted. However, in some implementations, the modules may be combined such that each of the content nodes or segments are processed using each of the content recommendation engines 232, 324, 326 and a respective analysis result is selected for use based on an analysis of a correlation metric, which may be produced as part of the output from the content recommendation engines 232, 324, 326. This may simplify the process and reduce the number of operations required for processing a set of content nodes or segments. In either case, deployment of multiple content classifier or content generation engines may be executed in parallel to improve performance or leverage a distributed processing pipeline. Further, while there are three content classifier engines 222, 224, 226 and/or three content generation engines 232, 324, 326, there may be fewer or more engines or modules, depending on the implementation.

In another example implementation, the content generation module 230 includes one or more rule-sets and/or trained machine-learning models that are adapted for classifying content. Similar to as described above for the node or content segment creation, a ruleset and/or model may be used to analyze content (here content nodes or content segments) and identify a type of content that is contained therein. In one example, a content classification may be used to classify one or more of the nodes. The content classification model may include a transformer machine learning model that is trained using existing content nodes and a set of predetermined content node types. The content classification model may, in some cases, be trained using user-specific or tenant-specific data sets, which may allow the classification to be performed in accordance with user-specific or tenant-specific preferences or content types. The classification may also be performed using one or more rule sets that may be selected in order to distinguish different types of content. In some cases, the ruleset includes a set of keywords or key phrases that are typically associated with a particular content node type or content segment type. In particular, a content node or segment may correspond to a panel content node type if the content of the node contains a threshold number of keywords or key phrases associated with the panel content type. The node classification use one or more types of natural language processing to identify designated keywords or key phrases associated with a particular classification type. For example, the node classification may use a Term Frequency-Inverse Document Frequency (TF-IDF) analysis to identify keywords and map those keywords with a designated set that is associated with a particular node type. In one example, a node may be associated with a particular panel content node type based on the extracted or determined keywords having a sufficient correlation with a set of designated keywords associated with the particular panel type. Example panel types include: info panel types for highlighting additional or supplemental information; note panel types that are directed to a topical theme or key point of the content; warning panel types that are directed to cautionary explanations or narratives; or other panel types. Each type of panel may have an associated set of designated keywords or key phrases that can be used for classification. In one example, a panel having the highest correlation or number of keywords/key phrases may be selected as the content node type for the respective node.

In another example implementation, an embedded vector representation of the content node or content segment is evaluated with respect to a classifier vector or vector set. Content having a sufficient similarity score, using a cosine similarity or other technique, may be classified as having a corresponding panel content node type. In another example, the content of a node or segment is evaluated with respect to a model trained to identify structured content that may be represented by a table or other similar structured format. Content having multiple segments or elements that correspond to multiple categories or headings may be identified using the trained model and, thus, classified as having a table content node type. Further, content of particular node or segment may be analyzed using a model or a natural language processing technique to identify blocks of text that can be characterized as a narrative, using punctuation, sentence structure, and other grammatical properties in order to classify the node or segment as being a narrative content node type or narrative content segment type. In one example, text having an indented format, bulleted items, and/or enumerated content, may be classified in accordance with a table content node type.

In another example implementation, a generative engine or large-language model may be used to determine the content node types. For example, the content of the node may be provided to a generative output engine with a set of potential or candidate classification types. The corresponding generative response may indicate which potential or candidate classification type best corresponds to the content of the node. In some cases, a confidence score or other metric is provided with respect to each candidate classification, which may be used by the system to determine the content node type.

Once the content nodes or segments have been classified, the content is processed by a respective generation engine 232, 234, 236 (also referred to as content recommendation engines) of the content generation module 230. As discussed above, having a generation or recommendation engine that is selected in accordance with a particular content node type or content segment type allows for more tailored or accurate recommendations while also allowing for a more broad range of recommendations that may be handled by the system. While three engines are depicted in the present example, the number of engines that may be used may be fewer or more depending on the implementation. Example generation or recommendation engines include a narrative generation engine, a table generation engine, a panel generation engine, a title generation engine, table of content generation engine, and other types of engines.

In general, the generation or recommendation engines 232, 234, 236 may be classified as a deterministic engine, a generative engine, or a hybrid engine having deterministic and generative functionality. A determinist engine (one or more of the engines 232, 234, 236) may perform a deterministic set of operations to the content of the respective content node in order to produce a recommendation segment or snippet. The deterministic set of operations may insert one or more predetermined graphical elements other objects into the content of the node or segment to define the recommendation segment or snippet. The deterministic set of operations may also apply formatting changes, text content insertion, text content reformulation, and other operations to define the recommendation segment or snippet. In one example implementation, a panel generation engine includes a deterministic set of operations that includes a reformatting of the text into a panel object, which includes the insertion of a panel-type graphical object or region and a formatting of the text to be contained within the panel. In some cases, the panel generation engine also includes a generative engine, as described below, and the text or content inserted into the panel includes generative content produced by a generative output engine. In other cases, the panel generation engine is completely deterministic and does not include use of a generative engine.

A generative engine typically includes a or uses a prompt service 252, which constructs prompts for use with a generative output engine 254, similar to as described herein. A generative engine (one or more of the engines 232, 234, 236) may be used to produce narratives, table content, or other content that includes generated text content. Generative engines that produce narrative text or narrative content may be referred to herein as narrative generation engines. Similarly, generative engines that produce tables or other structured content may be referred to herein as table generation engines. As part of an example set of operations, a generative engine may cause generation of a prompt using the prompt service 252. The prompt may include predetermined query prompt text that includes instructions for generating a modified version of respective content from a content node or content segment. The prompt also includes at least a portion of the content extracted from the content node or content segment. The instructions may include instructions for modifying the writing style, length, tone, technical detail, or some other property of a narrative, particular for, but not limited to, a narrative generation engine. The instructions may also include instructions for generating content for cells of a table, and formatting instructions for the table including example input-output pairs and a formatting schema, particularly for, but not limited to, a table generation engine.

For a narrative generation engine, the predetermined query prompt text may include a particular transformation to be applied to the extracted content. In one implementation, the transformation is determined based on a prior or additional prompt provided to the generative output engine 252 with predetermined query prompt text that includes a set of candidate transformations and instructions to select or predict one or more transformations that should be applied to the extracted content, also included in the prompt. The predicted transformation(s) may be then provided to a second prompt, along with query prompt text that includes instructions for performing the transformation, and the extracted content. Other techniques for operating a narrative generation engine may also be used. For a table generation engine, the predetermined query prompt text may include instructions regarding the generation of a multi-dimensional array or data object based on the payload or included extracted content. The instructions may also include formatting constraints regarding the minimum or maximum element or cell token limit, topical relationship constrains, and other constraints or instructions.

The prompt service 252 may also add extracted content or other system data to the prompt in order to further customize the results for a particular user. In one example, context from the user's current session including data extracted from the user's profile and/or user-generated content may be added to the prompt to help define user-specific preferences and writing style. In one example, a user role, job description, group or team membership or other data from the user's profile may be added to the prompt. As a further example, content extracted from other content items authored by the user may be added to the prompt for style guidance. Content may also be extracted from team-or group-authored content (content generated by other users within a team or user group) may be added to the prompt. Similarly, a tenant specific or site specific content excerpt may be added to the prompt. In some cases, the user is able to designate which content or style library may be used, which the prompt service 252 may use to generate a respective prompt. Similar to other examples described herein, a formulated prompt is provided to a generative output engine 252 using an application programming call or other technique. In response, the generative output engine 252 produces a generative response, which may be used by the content generation module 230 in formulating the recommendation segment or snippet.

As part of the content generation module 230 or in a separate module, the content that is generated by the deterministic and/or generative engines may be post-processed or further processed in order to produce the recommended segments or snippets. As part of this operation or set of operations, additional rule sets may be applied to check the generated content with respect to a set of quality criteria or standards. Similar to as described with respect to other embodiments, herein, additional policy and other content checks may also be performed on the content. Further, in some embodiments the rich text similar to the original content may be restored or generated. In implementations in which placeholders were used in place of rich text elements or objects, the placeholders may be replaced with elements or objects that conform with the respective rich text format and content. Specifically, placeholders can be identified using the corresponding tags or otherwise designated characters and the payload extracted. In some cases, the payload or other aspects of the placeholder are used to identify the relevant object to be replaced. In some cases, the payload may change due to the processing by the content generation module 230 or other aspect of the system and the modified payload may be reflected in the replaced element or object. Continuing the example from above, if a previous mention-type object reference a particular name (e.g., “johndoe”), which was stored as a payload in the placeholder and then modified by a prior operation to a modified name (“john_m_doe”), the replaced mention-type object may be modified to reflect the change in the payload (e.g., @john_m_doe).

Each of the generated recommendation segments or snippets may be stored in a content store 240 for use by the platform backend 214, 216 and/or the platform frontend 202. In some cases, the recommendation segments or snippets are stored with permissions data, creation timestamp data, and other data related to the original content or the operations of the processing performed by the system 200. In some instances, the recommendation segments or snippets are stored with a hash or other representation of the original content, which may be used to determine if the recommendation segments or snippets are based on modified or outdated content. In some instances, the recommendation segments or snippets are stored with a modification flag, which may be negative or in a first state until the underlying or original content is changed, in which case the modification flag may be changed to a positive or second state. This allows for the display of previously computed recommendation segments or snippets that may remain relevant due to an unchanged or unmodified original content node or snippet.

In some implementations, the recommendation segments or snippets are not stored in a separate memory store like the content store 240 and may be stored, at least temporarily, in a memory of a platform backend 214, 216 or a memory of the platform frontend 202. The permissions data, timestamp, modification flag, and other data can be stored in the memory of the platform backend 214, 216 and/or the platform frontend 202. In some cases, the memory store is cleared for every session and/or may be cleared in accordance with a time interval or other cache maintenance criteria.

The recommendation segments or snippets may be used to generate selectable graphical objects that are rendered or displayed in a graphical user interface. As described below with respect to FIGS. 4A-4D, the selectable graphical objects are displayed in a recommendation panel and may be selected to cause the respective recommendation segments or snippets to be displayed and, in some cases, replace the content associated with the original content node or segment.

FIG. 2B depicts another example system and process flow for generating content for a content collaboration platform. Specifically, FIG. 2B depicts an example system 250 that includes various process modules or operations that may be implemented using hardware and networked computer components described herein. While each of the modules or processes may be described with respect to a particular software implementation, the system 250 includes the use of hardware elements including networked electronic devices, such as servers, client devices, and backend components described elsewhere in this description. A description of the hardware is not repeated with respect to FIG. 2B to reduce redundancy and improve clarity.

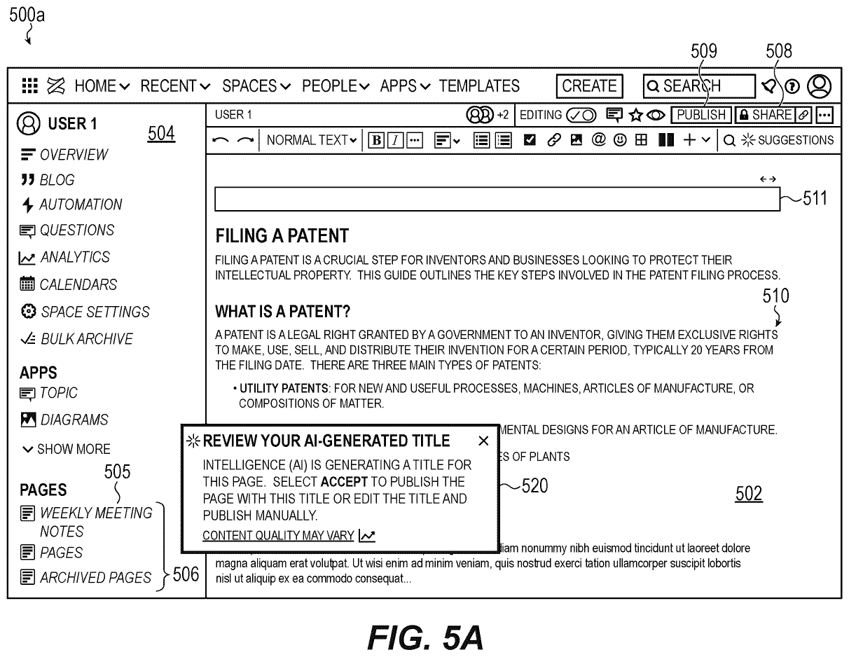

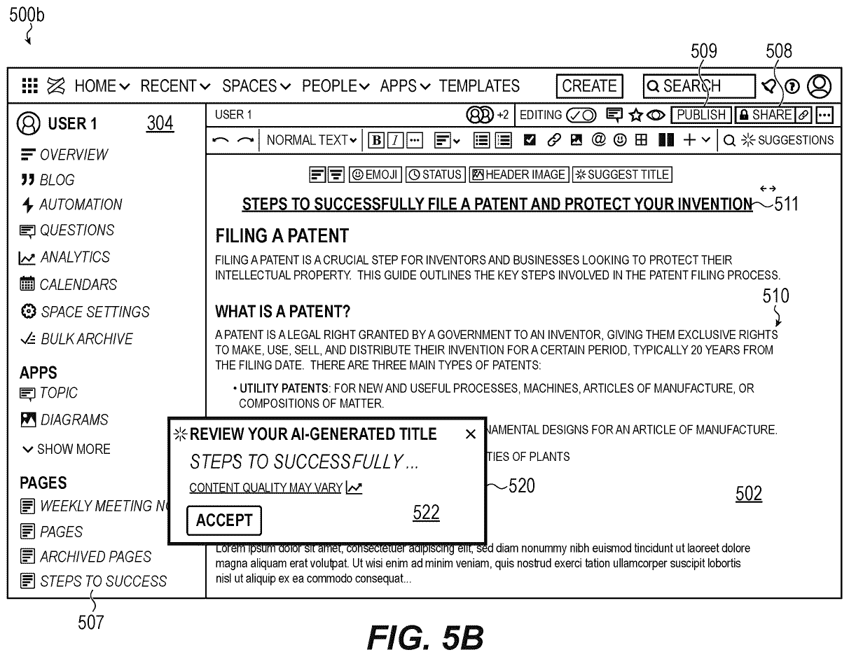

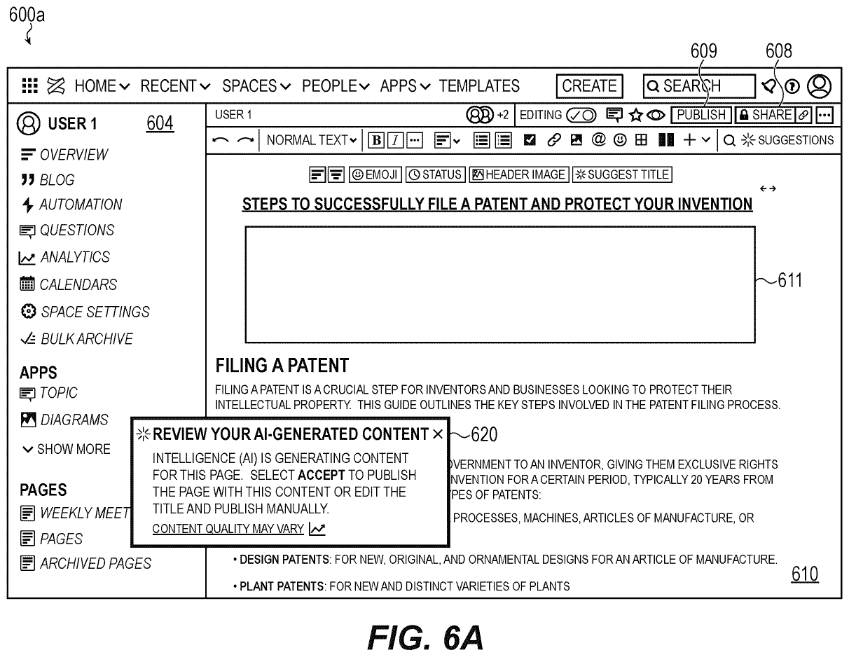

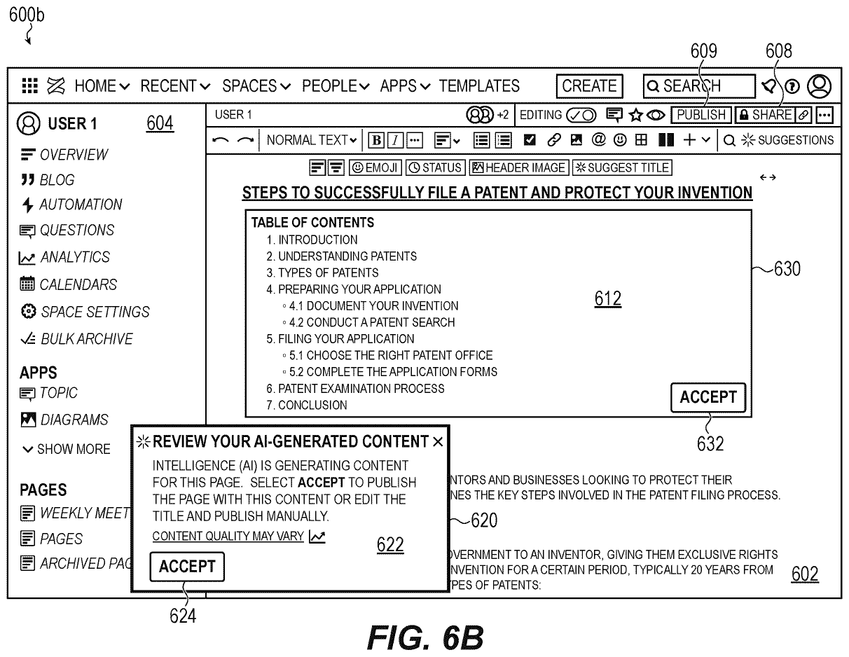

FIG. 2A depicts a system 250 that can be used to generate recommended content and supplemental content for a current content item being viewed or edited by an authenticated user. As discussed previously, the system may generate and display recommended or supplemental content to the user, which may be used to modify or edit a current content item. The recommended content may be displayed as selectable recommended objects or items within a recommendation region or panel of the graphical user interface in order to provide the recommendations within the current context of the platform. Additionally, as described in more detail below with respect to FIGS. 5A-6B recommended supplemental content may be displayed in a graphical object, such as a window or panel, of the graphical user interface.

In the example system 250, similar to the previous example, the user accesses the system using a platform frontend application, which may be operating on the hardware of the client device, also referred to as platform frontend 202. The platform application of the platform frontend 202 may include a browser or other web-enabled application that is adapted for use with a web-based platform backend or other similar service over a computer network like the web or internet. In other examples, the platform application of the platform frontend 202 is a dedicated client application that is adapted to communicate with a dedicated backend or other server system via a computer network. The example system 200 includes platform backends 214, 216, which may be either web-based servers or dedicated backend servers, depending on the implementation. The frontend application of the platform frontend 202 provides a graphical user interface for the platform, which may include content creation interfaces, content viewing interfaces, and other interfaces for interacting with the content and features of the platform backend. Example graphical user interfaces are described in more detail below with respect to FIGS. 3-4D and 5A-6B.

Similar to the previous example, the platform backends 214, 216 (also referred to as backend applications operating on one or more servers or similar hardware) provide the platform functionality and access to respective content stores 215, 217. Together, the platform backends 214, 216 may form part of a federated application service or system 210. The federated system 210 may leverage a common authentication service 212, shared or linked user accounts, and may exchange information using dedicated and/or integrated communication gateways. Each platform backend 214, 216 may provide the backend for a particular type of content collaboration platform.

In one example, a user operating a platform frontend (also referred to as a platform application operating on a client device) is authenticated with respect to one or more of the platform backends 214, 216 using an authentication service or module 212. The authentication module 212 may authenticate a user using authentication credentials that include a username and password or other authentication credentials like an authentication token or other data issued by a coordinating or recognized authentication service. In some cases, the authentication module 212 may employ or utilize a single-sign-on (SSO) service, which may be leveraged across multiple platforms or applications. Authentication of the user ensures that the platform frontend is an authorized frontend and that the user has an active and valid account with the platform backend(s) 214, 216. Authentication is also used to associate user activity with a particular user account in order to manage content permissions and provide appropriate content creation attribution. User activity logs, user interaction logs, and other activity logs may also be associated with or tracked using the user account of the authenticated user.

Subsequent to a successful authentication, the platform frontend may cause display of a graphical user interface of the content collaboration platform. The graphical user interface may be a content creation interface in which the user can provide user-generated content for generating an electronic page or document, issue, source code, project content, or other type of content item hosted by the respective content collaboration platform. In the examples of FIGS. 3-4D and 5A-6B, the graphical user interface is a document or page editing interface that includes an editor configured to receive user-generated content. In some implementations, the user-generated content includes text, image, video, audio, and other formats and classes of user content. The text content may be structured rich text or encoded rich text content in which editor-specific or platform-specific objects or elements may be generated. In some implementations, the content may be formatted as a structured data representation which may be formatted using JSON, XML, or other schema or a custom syntax. The structured rich text may be adapted for programmatic manipulation provided by a particular editor or rendering engine. For example the rich content may include @mention objects, selectable graphical objects, embedded content, special characters, content regions, content panels, and other similar elements. As described herein, the recommendation generation system 250 may preserve some existing references or content and, in some cases, may generate new editor-or platform-specific objects.

The content recommendation or supplementation operations of system 250 may be initiated in response to, or subsequent to, a trigger condition being satisfied. The trigger condition may evaluate if a particular user interface event or action has occurred alone or in combination with timing criteria and other factors. Example events include a content save event, content publish event, or other user input event. Corresponding trigger conditions include a content save condition (e.g., a document or page save condition), a content publish condition (e.g., a document or page publish condition), or other user input provided to the platform frontend. In one example, the user input may be the entry of a threshold amount of content (e.g., a viewable page of content), a carriage return (e.g., signifying the end of a paragraph or block of text), or a selection of a control (e.g., a UI button or other element) that is associated with a request for content recommendations or an automated evaluation of the current content. In some implementations, the trigger condition includes the evaluation of an amount of time that the user has been generating content, an amount of time since the user has entered a last content item (e.g., indicating that the user may have completed the content item or a portion of the content item), or another evaluation of timing and/or system activity. Example combination triggers may include an evaluation of an amount of new or modified content (e.g., exceeding a content modification condition or criteria) in combination with a time criteria, which may include a threshold amount of dwell time or inactivity subsequent to the generation of the content. In some cases, this type of trigger condition may cause the system to generate a snapshot or cached version of a document, which can be published to other users in a concurrent content editing environment and/or stored for future use.

In some cases, the system may momentarily pause, suppress, or suspend operations associated with the trigger condition until recommended content is generated and adopted by the user. For example, in some implementations, a page may not be published or shared or distributed until the content is determined to be sufficiently complete or determined to have expected content components. In some systems, a document or page may not be allowed to publish until a title is defined for the content item. This may be a requirement because the text of the title may be used to uniquely identify the content item within a particular content space (e.g., document space), project, or other collection of content items. As described in more detail below with respect to the various user interface examples, the title may be used to define an element in a hierarchical element tree (also called a page tree or a document tree), which may be displayed in a navigational region or panel and used to cause display of the respective content item. The hierarchical element tree may correspond to the hierarchical document structure for the given document or space. Missing title text or duplicate title text could cause operational issues with the hierarchical element tree or other aspects of the system that may rely in the title text for content item identification. The title text may also be used to construct a uniform resource identifier (URI) or other path that is used to access the content using a web-enabled application like a browser. Other content components, such as a brief description, content overview, or other content component may also be deemed necessary by the system, thereby causing a similar suppression or suspension of the operations associated with the trigger. Further, content components or other elements may be recommended in accordance with the content creation policies or guidelines of the content collaboration platform and the operations associated with the trigger may be suppressed, paused or suspended in order to allow the user to review and accept or adopt content recommendations before proceeding with a publication, share, or distribution of the content item.

In response to or subsequent to the trigger condition being satisfied, similar to previous examples, the content extraction module 204 may extract content from the current content item (e.g., an electronic document or page) either directly from the platform frontend 202 or from the platform backend 214 or 216. In the case of the latter, the content extraction module 204 may formulate a query or call to the platform backend 214 or 216 which may include a content identifier and authentication token or other authenticating information. In other cases, the content extraction module 204 is integrated with one or more of the platform backends 214, 216 and may access content directly from a respective content store 215, 217, which may include a platform content monolith or other structured data storage. In addition to the explicit content, the module 204 may extract metadata including user-generation attribution, content creation date, document space data, linked or related content items (linked through a hierarchical document structure or page tree), and other metadata. The module 204 may also collect current context including current or recently accessed content items, user profile data or user-preference settings, user-specific content samples or excerpts, user-group or project information, and other context information. In some cases, the module 204 may extract or access a content graph or knowledge graph that relates content items, user accounts, teams, projects, and other system elements using a respective edge or defined relationship. Data extracted from the content graph and the extracted context may be used to customize the recommendations and supplemental content for the particular user or present use case. This allows the recommendations to more closely resemble the user-generated content by the same user or other users that may be related to the user through interactions and content of the respective platform.

In the example of FIG. 2B, the content extracted from the content item is analyzed to determine or identify one or more missing content components (e.g., missing document components or missing page components). The content analysis module 260 may be used to perform these operations in order to identify content that may be required or preferred given the operational requirements of the system or content policies that apply to content creation operations. As described above, the system 250 may be adapted to identify missing document components, such as a title, content summary, content overview, table-of-contents, or other components that may be required or recommended given the particular content collaboration platform or content creation interface. In some implementations, the module 260 may be adapted to evaluate the content of the content item with respect to a content criteria, which may also be referred to as a sufficiency criteria. The content criteria or sufficiency criteria may include a ruleset or logic, which specifies a set of expected components or list of elements that can be used to evaluate the sufficiency or completeness of the content. There are multiple techniques for evaluating content criteria for detecting missing content components using the content analysis module 260, examples of which are described below.

In one example implementation, the content analysis module 260 may be configured or adapted to analyze the user-generated content of the content item extracted by the module 204 in order construct or obtain a document node structure. In some cases, the user-generated content may include an existing partial or complete document node structure, which may be used or supplemented by the module 260. In other cases, the module 260 may generate or construct the document node structure by parsing the user-generated content. As described previously with respect to FIG. 2A, the content may be parsed to identify existing structural components defined by the structured rich text or encoded content, which may include tags or other marked text, text blocks, formatting objects or special objects like panels, frames, or other graphical elements, formatting elements, and other content. The parsed content may be stored as a structured data element like a JSON object or other similar schema. The content nodes or content segments may then be identified or defined based on the parsed content. In one example, a tokenization or other technique for grouping the content elements may be performed in order to identify text nodes or segments of related text, content sections or groupings, and other related elements of the content. The grouping operation may identify sections, paragraphs, text blocks, and other content groupings using a natural language processing technique that uses the grammatical structure, punctuation, content formatting, and other attributes of the content to define each of the content nodes or content segments.

In another example implementation a generative output engine (e.g., the generative output engine 252 or other example described herein) may be used to construct or define the document node structure. For example, the module 260 or other service may generate a prompt that includes the extracted content and predetermined query prompt text that includes instructions for defining content segments or portions that are related by location, topic, and structure. The prompt may be provided to the generative output engine and the corresponding generative response may be used to define or construct the document node structure. The generative response may include generative content that is formatted in order to delineate or define related content portions, which may be used to define the nodes of the document node structure.

Once the document node structure has been obtained or constructed, the module 260 may evaluate the document node structure with respect to a set of expected document components or elements. The set of expected document components may include components that are required for operational functionality of the system, as discussed above with respect to a document title, document summary, or other content component. Additionally or alternatively, the set of expected document components may be preferred, suggested, or recommended components that correspond to document creation policies or practices that are adopted by a relevant aspect of the content collaboration platform. Thus, the term “expected document components” may not be strictly limited to components that are required or necessary by the system. The set of expected document components may define in whole or in part the content criteria or sufficiency criteria against which the content is evaluated.

In yet another example, the module 260 may include or access a trained machine learning-model that has been trained using existing user content. The machine-learning model may include a transformer or other similar model that has been trained to produce an output indicating the presence of one or more missing document components based on the extracted content, a document node structure, or other representation of the document content. The trained model may also be adapted to work in conjunction with one or more of the techniques described above and the content may be pre-processed or the output may be post-processed in order to determine or identify one or more missing content components. In this example, the operations of the model may be referred to as an evaluation of the content with respect to content criteria or sufficiency criteria as the operations of the model perform the logic or operations of criteria evaluation.

In response to detecting or identifying one or more missing content components, the system 250 may use a content generation module 270 to generate recommended supplemental content or other generative content, which may be provided to the platform frontend 202 for review and adoption by the user. Example recommended supplemental content that is provided to a graphical user interface of the frontend application is described in more detail below with respect to FIGS. 5A-6B.

In the present example, the content generation module includes discrete content engines 272, 274, 276, each may be adapted to generate different respective content depending on the type of missing content item that is identified by the module 260. For example, the content engine 272 may be adapted to generate recommended supplemental content that includes title text in accordance with the missing content component being a title. Similarly, the content engine 274 may be adapted to generate recommended supplemental content that includes a table-of-contents and the content engine 276 may be adapted to generate content that includes a content summary or content overview. These are only provided as examples and other content engines may be used. The particular content engine (272, 274, 276) may be selected based on a classification of the missing content component or using a content tag generated by the module 260. Example content classification techniques are described above with respect to the module 220 of FIG. 2A and may be used in conjunction with the system 250 of FIG. 2B.

Each content engine 272, 274, 276 may be adapted or configured to generate a prompt with respective predetermined query prompt text that includes instructions for generating respective recommended supplemental content. The instruction may include text-based instructions regarding the type of content to be generated, for example formatting, length, and other attributes of the requested supplemental content. The predetermined query prompt text may be joined with at least a portion of the content extracted from the user-generated content. As described in more detail above with respect to the process 200 of FIG. 2A, a text or converted version of the user-generated content may be used in the prompt to reduce errors or inconsistencies that may be generated if the original structured rich text content is used without pre-processing or conversions. Also, as described previously, placeholder elements or segments may be used in place of particular rich text elements or objects and then replaced in the generative response produced by the generative output engine 254. In this way, the original rich text elements or objects may be preserved in the recommendation generation process. The prompt generated by each content engine 272, 274, 276 may be provided to the generative output engine 254 via the prompt service 252 similar to described with respect to the example system 200 of FIG. 2A, a description of which is not repeated in order to reduce redundancy.

Each content engine 272, 274, 276 may also be adapted to gather additional data or content that can be used to improve the accuracy or relevance of the supplemental content. In particular, each content engine 272, 274, 276 may be adapted to extract or obtain reference content from the respective platform 214, 216, which may provide further context and examples for the generative output engine 254. In some examples, the content engines 272, 274, 276 may construct a prompt that includes a user role or other attribute extracted from a user profile associated with the user account. This may provide further customization of the supplemental content with respect to a particular user or type of user. The reference content added to the prompt may also include other content associated with the user to improve the correlation of the supplemental content with respect to a user's style or formatting preferences. For example, a respective content engine 272, 274, 276 may be adapted to identify one or more other documents or content items having an author or creator associated with the user account operating the platform frontend 202. The prompt may further include content extracted from the identified documents or other content items. This may be performed using an indexed search service or other similar service that is adapted to identify content within the content stores 215, 217 using keywords, text segments, or other elements extracted from the current document or content item. The system may also use a similarity criteria when selecting relevant content to include, which may be used to rank or select content returned in a search and/or select portions of the content for inclusion in the prompt. Evaluation of a similarity criteria may be performed using an embedded vector representation of the content and a similarity analysis, such as a cosine similarity, Euclidian distance, or other similarity evaluation technique.

In some cases, the current hierarchical document structure (represented by a respective hierarchical element tree in the graphical user interface) may be used to provide particularly relevant reference content. Because the content in the same document structure may share organizational and formatting structures, a respective content engine 272, 274, 276 may be configured to identify one or more other documents or pages referenced by the document structure in order to further adapt the prompt. In one example, a similarity analysis or criteria may be used to identify one or more documents in the structure having content that corresponds to the current document or content. Relevant portions of the content may be extracted from the identified content and added to the prompt. In one specific example, title text from other documents in the document structure may be added to the prompt as examples in order to match title format and style. Further, documents having similar content and/or level of hierarchy in the document hierarchy structure may be selected for inclusion as similar documents at the same or comment level of hierarchy may provide insight into the user's naming conventions. For example, meeting notes or project definition documents may follow a particular naming convention and, inclusion of those examples may allow the supplemental content (recommended title text) to more closely correspond to existing naming conventions and styles. As discussed herein, the title text may be used to define a corresponding element of the hierarchical element tree in the interface. Having some congruency or similarity in title text style may allow the user to more easily identify and select relevant content and may help the automatically generated titles be more indistinguishable from the other manually created titles.

As described previously, the title text in a particular document space or hierarchical document structure may be required to be unique in order to allow the system to provide navigational and organizational operations. As described above, a unique title may allow the title to be used (alone or in conjunction with other information provided by the hierarchical document structure) to generate unique URIs or other content identifiers that can be used for easy content navigation and retrieval. In some cases, the respective content engine 272, 274, 276 may perform a uniqueness evaluation with respect to other titles in the hierarchical document structure. In accordance with the recommended content of the generative response being identical to the other title text extracted from the other documents, the generative response may be modified to produce a unique recommended supplemental content. In one example, additional characters or text is added to the generative response to provide the required uniqueness. In another example, modifying the generative response includes generating a second or subsequent prompt that includes at least a portion of the user-generated content, other title text extracted from the other documents and instructions to generate non-identical text or reject identical proposals. The corresponding second or subsequent generative response may then be used as the recommended supplemental content. Other techniques for modifying the generative response may also be used.

The output of a respective content engine 272, 274, 276 may then be provided to the platform frontend 202, which may cause display of the content in the corresponding graphical user interface. As described in the user interface examples, below, the user may browse, edit, and/or accept the supplemental content, which may then be automatically added to the user generated content. Further, as described above, insertion of the supplemental content may cause the operations associated with the original trigger to be resumed, which may result in the document or page being published, shared, or distributed. These and other resulting operations of the process described with respect to FIGS. 2A and 2B are described below with respect to FIGS. 3-6B.

FIG. 3 depicts an example graphical user interface 300 of a content collaboration platform, as described herein. In particular, the graphical user interface 300 includes a content region 302, which may include or operate an editor configured to receive user-generated content 310. In the present example, the content collaboration platform is a documentation platform and the graphical user interface 300 is a document or page viewing and/or editing interface for managing document or page content. The same or similar techniques described herein may also apply to other content items associated with other platforms including issue content of an issue managed by an issue tracking platform, project content or a project profile managed by project management platform or project directory service, or source code of a source code management platform or service.

In the current example, the user-generated content or simply “content” 310 includes text, rich text, and other objects that may have been entered via the editor of the interface 300. The content may be analyzed or parsed to identify separate content nodes or content segments, in accordance with the operations described above with respect to FIGS. 2A and 2B. Specifically, the content of the page or document may be analyzed to identify a set of nodes or document node structure, which may be represented as a hierarchy or node hierarchy. In the example of FIG. 3, the content 310 includes a title 330, which may correspond to a first or title node. As described herein, title 330 may be required in order to publish the page or document since the text of the title may be used by a hierarchical element tree and other elements of the system. Also as described herein, the system may cause generation of the title and other supplemental content in response to a particular trigger condition being satisfied, such as a publication event, save event, or content share event.

The content 310 also includes a content panel 312 or panel object, which includes multiple text blocks 314, 416, 318. The content panel 312 may include a brief summary of the content along with key points or content highlights. The content panel 312 may be a special object that is supported by the editor or platform and may be referred to herein as a rich text object. As the document or page is processed using the process 200 of FIG. 2A discussed above, the content panel 312 may correspond to a content node or content segment and each of the text blocks 314, 316, 318 may correspond to a respective sub-node or sub-segment, which are children to the parent node of the content panel 312. Additional children may be defined from these sub-nodes, depending on the amount of content and the structure of the content 310 in the document or page. In this example, a parent node for panel 312 may be classified as a panel content node type or existing panel content node type and the text blocks 314, 316, 318 correspond to sub-nodes that may be classified as narrative content node types. Note that the existing panel node content type may be contrasted with a proposed panel node content type that is not currently formatted as a content panel but qualifies or can be classified for suggesting that the content be converted to a content panel using the system 200 of FIG. 2A, for example.

Further, as shown in FIG. 3, the content 310 includes additional text blocks 320, 322, 324, which may be used to generate additional content nodes or content segments. In this example, the text block 320 may correspond to a node that is classified as a narrative content node type. The text block 3210 also includes rich text elements like the selectable graphical object 321, which includes content extracted from an associated content item (e.g., another page or document) and is selectable to cause display of the respective content item in the respective platform. As discussed previously, structured rich text elements like the selectable graphical object 321 may be preserved in the processing of the content nodes or segments and used in the content recommendation segments or snippets as shown in the examples of FIGS. 4A-4D.

As shown in the example of FIG. 3, the text block 322 includes a bulleted list of items, each item including a corresponding selectable graphical object 323. In some implementations, the text block 322 may correspond to a content node or segment and each bullet may correspond to a sub-node or segment. Due to the formatting or structure of the text block 322, the respective content node or content segment may be classified as a table content node type. For example, because the text block 322 or corresponding node includes discrete content segments having a relatively small size (satisfying a classification criterion or other aspect of a rule set) the node analysis module may classify the node as predicted to be able to be converted into a table or other similar structured format. As a result, the node or segment may be processed using a corresponding table generation engine, which may cause generation of a recommendation segment or snippet that includes a table of content that is generated using the content of the corresponding node or segment associated with the text block 322.

The text block 324 includes a similar set of bulleted or listed elements, each including a selectable graphical object 325. In this example, the selectable graphical objects 325 are each associated with a respective issue content item managed by a separate issue tracking platform. Selection of a particular selectable graphical object 325 may cause the interface to be redirected to a view of the content of the particular issue as viewed within a graphical user interface of the issue tracking platform. Each selectable graphical object 325 includes content extracted from a respective issue, which may be obtained using an application programming interface call or other similar technique. A change to the respective issue content on the issue tracking platform may result in the display of a corresponding change to the extracted content displayed in the selectable graphical object 325. Similar to the example, above, the text block 324 may correspond to a parent node or segment and each bullet or list item may correspond to a sub-node or segment. Also similar to the example discussed above, the parent node of text block 324 may be classified as a table content node type or segment and processed accordingly.

In the present example, the graphical user interface 300 is generated by a frontend application, which is a browser application operably coupled to a web-based backend application or platform. The interface 300 can be rendered by a client device (e.g., client device 104, 106 of FIG. 1), which may be a personal electronic device such as a laptop, desktop computer, tablet and the like. The client device can include a display with an active display area in which the user interface 300 can be rendered. The user interface can be rendered by operation of an instance of a frontend application associated with a backend application that collectively define a software platform, as described herein. In some examples described herein, the graphical user interface 300 may be displayed subsequent to, or in response to, an authentication of a user of the content collaboration platform.

In general, the graphical user interface 300 of FIG. 3 includes a content region 302 also referred to as a content panel, which displays the content 310 of a respective electronic document or page. The content 310 may include text content, selectable graphical objects, rich text content, images, videos, and other content. The content region 302 may include or operate an editor that is configured to receive user-generated content, which is used to generate or modify the content 310 of the document. As shown in FIG. 3, the user-generated content or content 310 may include what is referred to as structured rich text content, which may be formatted in accordance with a formatting scheme, such as HTML, XML, Atlassian Document Format (ADF), or other similar scheme or language. The particular schema may also be referred to as a platform-specific or editor-specific formatting schema. In some examples, the text content can also be displayed in line with hypertext, graphical elements and other content that is enabled by the editor instantiated by the frontend application within the content region 302.

The graphical user interface 300 also includes a navigational region 304, also referred to as a navigational panel, which includes a set of selectable elements 305 that are selectable to cause display of respective content items or navigate to other aspects of a document space. In this example, the navigational region 304 includes a hierarchical element tree 306 also referred to as a page tree, which includes an array of selectable tree elements 305 that are hierarchically arranged in accordance with parent-child relationships between respective documents of the document space. The elements may include a short title and/or graphical elements that indicate the subject matter and type of content item associated with each respective element. Many of the elements may also be selected and moved within the hierarchical element tree 306 in order to redefine a parent-child relationship between the respective elements. The collection of elements depicted in the navigational region 304 maybe associated with a respective space, also referred to herein as a content space, page space, or document space. A space defines a collection of content items for which the space creator is the default administrator having default read, write, view, and control permissions with respect to all items within the space. Content and navigational regions 302, 304 may also be referred to herein as “panes,” “panels,” or “areas” of the graphical user interface 300.

The graphical user interface 300 also includes a control bar 308 that includes an array of selectable controls for navigating to different spaces, documents, applications, or modules. The interface 300 also includes controls 309 for managing the content and interface modes of the graphical user interface 300. Generally, the graphical user interface 300 provided by the frontend or client application may operate in one of a number of different modes. In a first mode, a user may create, edit or modify page or other digital content. This mode or state of the graphical user interface 300 may be referred to as an editor user interface, content-edit user interface, a page-edit user interface, or document-edit user interface. In a second or other mode, the user may view, search, comment on, or share the electronic document, page, or digital content. This mode or state of the graphical user interface may be referred to as a viewer user interface, content-view user interface, a page-view user interface, or document-view user interface. The graphical user interface may be implemented in a web browser client application using HTML, JavaScript, or other web-enabled protocol.

The graphical user interface 300 may allow the user to create, edit, or otherwise modify user-generated content that is stored as an electronic page. The electronic page or other digital content may be rendered on a client device by the content collaboration service upon authorization/authentication of the user by the authentication/authorization service, and based on permissions granted to the user as validated according to a user profile associated with the user. Further, the content that is rendered in the content region 302 may contain content extracted from or obtained from other content items having their own respective permissions profiles.

In accordance with the system 200 of FIG. 2A, the content 310 of the currently displayed page or document the interface 300 of FIG. 3 may be parsed to generate a set of content nodes or segments. The set of content nodes or segments may have a hierarchy of nodes and sub-nodes that are defined in accordance with the structure of the content 310. Specifically, different levels of node hierarchy may be defined in which parent nodes or segments of content include or relate to one or more sub-nodes or segments, which may also include or related to further sub-nodes or segments. Depending on the implementation, a particular level of hierarchy may be processed or all of the nodes of the hierarchy may be processed to define respective content node types and processed using a respective content recommendation engine. The result of the processing may produce a corresponding set of recommendation segments or snippets, as depicted in FIGS. 4A-4D .

FIG. 4A depicts an example graphical user interface 400a including a recommendation region 410 includes a set of selectable recommendation objects 411-416 that have been generated in accordance with the techniques described herein. Specifically, in response to a trigger condition being detected, the page content 310 may be analyzed to determine or generate the set of content nodes or segments, which are processed using a system similar to system 200 of FIG. 2A. As discussed previously the trigger condition may be one or more of a document or page save condition, a document or page publish condition, user input condition (other condition triggered by a user input), or other condition. The resulting recommendation segments may be used to generate the selectable recommendation objects 411-416 displayed in the recommendation region 410.

Each of the selectable recommendation objects 411-416 may be displayed in an order that corresponds to an order of the content nodes or segments of the content 310. In some implementations, the selectable recommendation objects 411-416 are displayed in accordance with a hierarchy using, for example, indented elements, collapsible and/or expandable controls, or other user interface techniques. A user input with respect to a particular selectable recommendation object 411-416 may cause the graphical user interface 400a to highlight or visually emphasize a corresponding portion of the content 310 (corresponding to the respective content node or segment). The highlighting or visual emphasis may include displaying a temporary frame or outline of the respective portion of content, displaying the portion of the content with an increased size or darker color, displaying a background highlighting or other element with respect to the portion of the content, or other technique. In this example, a user input (e.g., a cursor hover input) provided with respect to selectable recommendation element 411 causes a highlighting or visual emphasis of the corresponding portion of content 320 that was used to generate the respective recommendation element 411. In this way, a user can browse the recommendation elements to identify corresponding recommendations and visually identify the respective portion of the content 310 to which they apply.

A different user input with respect to a particular selectable recommendation object 411-416 may cause display of a recommendation segment or generative response within a window or other object within the graphical user interface 400a. As used herein, the generative response may be used to refer to content that was generated by a generative output engine as part of a respective recommendation engine operation. In some cases, the generative response has been post-processed or modified before being displayed in a respective window or other object of the graphical user interface 400a. For example, in some cases, the generative response may be modified to have placeholder content replaced with rich text elements or other content. The generative response may also be modified to format the content to comply with formatting, platform-specific, or editor-specific elements such that the generative response resembles or more directly corresponds in format to the original content segment of the content 310. FIGS. 4B-4D, discussed below, depict example use of a window for displaying the generative response or recommendation segment.

FIG. 4B depicts an example graphical user interface of the documentation platform, in accordance with embodiments described herein. In particular, FIG. 4B depicts an example graphical user interface 400b having a recommendation window 440 that is displayed or rendered in response to a user input (e.g., a selection) with respect to a respective selectable recommendation element 411. The graphical user interface 400b includes many shared elements discussed above with respect to interface 400a, a discussion of which is not repeated to reduce redundancy and improve clarity.

As discussed above, each of the selectable recommendation elements may be associated with a recommendation segment or snippet that may be generated in accordance with the process and system described above with respect to FIG. 2A. In this example, the text block 320 may have a node or segment that is classified as a narrative content node type, which results in the node or segment being processed using a generative recommendation engine. In this example, in accordance with the node or segments being classified as a narrative content node type, the generative recommendation engine may be a narrative generation engine that is adapted to produce a narrative-style output.

As shown in FIG. 4B, the graphical user interface 400b includes a recommendation window 440 that includes the recommendation segment or snippet 442 that corresponds to the text block 320. The recommendation segment or snippet 442 includes the generative response modified to include special objects or structured rich text elements. Specifically, in this example the segment or snippet 442 includes the selectable graphical object 443, which was preserved from the original content. As described previously, structured rich text elements like the selectable graphical object 443 may be preserved using a placeholder or other similar element that may include designated text characters allowing for processing using, for example, a text-based generative output engine. In this example, the recommendation segment or snippet 442 is displayed in a floating window element that overlaps or is overlayed with respect to the content 310 displayed in the content region 302. In other implementations, the window 442 may be integrated as a distinct panel or region of the graphical user interface 400b. Other implementations may include displaying the recommendation segment or snippet 442 in another manner such as a floating text object, content inserted into the content 310, or other technique.

In the example of FIG. 4B, the recommendation window 440 includes selectable controls 444. The selectable controls include an option for inserting the recommendation segment or snippet 442 at a location within the content 310 of the page or document. The selectable controls also include an option for replacing the text block 320 with the recommendation segment or snippet 442 such that the proposed recommendation is displayed at the location within the document of the text block 320 and the text block 320 is deleted from the content 310. In some implementations, the recommendation segment or snippet 442 may be edited within the window 440. Specifically, the window 440 may display the recommendation segment or snippet 442 within a field that operates an editor similar to the editor provided for the content region 302. This may allow the user to make further modifications or edits to the recommendation segment or snippet 442 before inserting or replacing the content within the document or page. The editor of the window 440 may support the same or similar structured rich text content as the editor operating within the content region 302.

FIG. 4C depicts an example graphical user interface of the documentation platform, in accordance with embodiments described herein. In particular, FIG. 4C depicts an example graphical user interface 400c having a recommendation window 440 that is displayed or rendered in response to a user input (e.g., a selection) with respect to a respective selectable recommendation element 412. The graphical user interface 400c includes many shared elements discussed above, a discussion of which is not repeated to reduce redundancy and improve clarity.

As discussed above, each of the selectable recommendation elements may be associated with a recommendation segment or snippet that may be generated in accordance with the process and system described above with respect to FIG. 2A. In this example, the text block 322 may have a node or segment that is classified as a table content node type, which results in the node or segment being processed using a generative recommendation engine. In this example, in accordance with the node or segments being classified as a table content node type, the generative recommendation engine may be a table generation engine that is adapted to produce a table, matrix, or similarly formatted output.

As shown in FIG. 4C, the graphical user interface 400c includes a recommendation window 450 that includes the recommendation segment or snippet 452 that corresponds to the text block 322. The recommendation segment or snippet 452 includes the generative response modified to be represented as a table formatted in accordance with the corresponding editor and/or rendering service. Similar to previous examples, the segment or snippet 452 includes special objects or structured rich text elements. Specifically, in this example the segment or snippet 452 includes the selectable graphical object 453, along with other similar elements, which were preserved from the original content, as described previously.

In the example of FIG. 4C, the recommendation window 450 includes selectable controls 454. The selectable controls include an option for inserting the recommendation segment or snippet 452 at a location within the content 310 of the page or document. The selectable controls also include an option for replacing the text block 322 with the recommendation segment or snippet 452 such that the proposed recommendation is displayed at the location within the document of the text block 322 and the text block 322 and associated content is deleted from the content 310. As described previously, in some implementations, the recommendation segment or snippet 452 may be edited within the window 450. Specifically, the window 450 may display the recommendation segment or snippet 452 within a field that operates an editor similar to the editor provided for the content region 302. This may allow the user to make further modifications or edits to the recommendation segment or snippet 452 before inserting or replacing the content within the document or page. For example, the user may modify the table (e.g., add or delete rows or columns) or the contents of the cells of the table within the window 450.

FIG. 4D depicts an example graphical user interface of the documentation platform, in accordance with embodiments described herein. In particular, FIG. 4D depicts an example graphical user interface 400d having a recommendation window 460 that is displayed or rendered in response to a user input (e.g., a selection) with respect to a respective selectable recommendation element 415. The graphical user interface 400d includes many shared elements discussed above, a discussion of which is not repeated to reduce redundancy and improve clarity.

As discussed above, each of the selectable recommendation elements may be associated with a recommendation segment or snippet that may be generated in accordance with the process and system described above with respect to FIG. 2A. In this example, the text block 470 may have a node or segment that is classified as a panel content node type, which results in the node or segment being processed using a panel recommendation engine. In this example, in accordance with the node or segments being classified as a panel content node type, the panel generation engine may be adapted to produce an output that is formatted as a panel graphical element that includes a narrative or text portion. As discussed previously, the panel recommendation engine may include generative functionality or may use a generative recommendation engine in order to reformulate or generate the text portion of the panel graphical element.

As shown in FIG. 4D, the graphical user interface 400d includes a recommendation window 460 that includes the recommendation segment or snippet 462 that corresponds to the text block 470. The recommendation segment or snippet 462 includes the generative response modified to be represented as a table formatted in accordance with the corresponding editor and/or rendering service. Similar to previous examples, the segment or snippet 462 includes special objects or structured rich text elements. Specifically, in this example the segment or snippet includes a panel element or block that corresponds to a special structured rich text element.

In the example of FIG. 4D, the recommendation window 460 includes selectable controls 464. The selectable controls include an option for inserting the recommendation segment or snippet 462 at a location within the content 310 of the page or document. The selectable controls also include an option for replacing the text block 470 with the recommendation segment or snippet 462 such that the proposed recommendation is displayed at the location within the document of the text block 470 and the text block 470 and associated content is deleted from the content 310. As described previously, in some implementations, the recommendation segment or snippet 462 may be edited within the window 460. Specifically, the window 460 may display the recommendation segment or snippet 462 within a field that operates an editor similar to the editor provided for the content region 302. This may allow the user to make further modifications or edits to the recommendation segment or snippet 462 before inserting or replacing the content within the document or page. For example, the user may modify the text or other content of the content panel within the window 460.

FIGS. 5A-5B depict example graphical user interfaces of a content collaboration platform, as described herein. In particular, the graphical user interface 500a, 500b includes a content region 502, which may include or operate an editor configured to receive user-generated content. Similar to previous examples described above, the content collaboration platform is a documentation platform and the graphical user interface 500a, 500b is a document or page viewing and/or editing interface for managing document or page content. The same or similar techniques described herein may also apply to other content items associated with other platforms including issue content of an issue managed by an issue tracking platform, project content or a project profile managed by project management platform or project directory service, or source code of a source code management platform or service.

Similar to the previous examples, the user-generated content or simply “content” 510 includes text, rich text, and other objects that may have been entered via the editor of the interface 500a, 500b. The content 510 may be parsed or analyzed to obtain or generate a document node structure including separate content nodes or content segments, in accordance with the operations described above with respect to FIGS. 2A and 2B. Specifically, the content of the page or document may be analyzed to identify a set of nodes or document node structure, which may be represented as a hierarchy or node hierarchy. In the example of FIG. 5A, the content 510 includes blocks of text, paragraphs, section headers, and other content nodes. Notably, the content 510 in this example does not include content (or a content node) that corresponds to a document title. As described previously, a document or page title may be required in order to publish the page or document since the text of the title may be used by a hierarchical element tree and other elements of the system. As described previously, the system may cause generation of the title and other supplemental content in response to a particular trigger condition being satisfied, such as a publication event, save event, or content share event.

As described previously with respect to FIG. 2B, the system may parse the content 510 of the current document in response to a trigger condition being satisfied. For example, the trigger condition may be satisfied in response to a user selection or input with respect to the publish control 509 or share control 508. The publish control 509 may initiate the publication or distribution of a draft document that is currently only visible to a designated set of user accounts having authorship or content creator status. Similarly, the share control 508 may initiate a sharing operation or set of operations for the current document, which may cause transmission of a copy of the document or a notification including a link to the document. The user may use the share control 508 for published or unpublished content, depending on the particular implementation of the content collaboration platform. Other trigger conditions may include a document save action, which may be initiated explicitly by the user or initiated automatically by the system in accordance with a timing and content creation criteria being satisfied. Also, as discussed previously, in some instances, the operations of the action associated with the trigger may be suspended, paused, or suppressed until supplemental content is generated and adopted or accepted by the user. The operations may be paused for supplemental content may include required content components, like a title, content summary, or other content elements. The operations may also be paused for non-required or suggested content components, which may also include content summaries, tables-of-content, or other content elements.

In the current example, the system may parse or analyze content 510 of the current document and evaluate the content 510 with respect to a content criteria, which may be a sufficiency criteria that can be used to determine a predicted completeness or sufficiency of the document content. A more detailed description of example evaluations is provided above with respect to FIG. 2B and may include the creation of a document node structure, which can be evaluated with respect to a set of expected document components or other similar ruleset or reference object. In response to the analysis and evaluation, the system may identify one or more missing document components with respect to the content 510. In the example of FIG. 5A, the system may identify or detect a missing title component due to the lack of any text in the content 510 corresponding to a title node or title segment. In this particular example, the system may cause display of a graphical object 511, which may include a box or region that indicates a location of the missing content component. As shown in FIG. 5B, discussed below, the graphical object 511, may serve as a placeholder for the supplemental content to be generated and may provide a visual indication of where the generated content may be inserted into the content 510. The system may also cause display of a graphical object 520, which may be a floating window object that overlays or overlaps at least a portion of the content region 502. The graphical object 520 may include a narrative that explains that a supplemental content process has been initiated and may identify which content component has been identified as being missing. The graphical object 520 may also include further instructions about how to proceed and/or notifications about a momentary suspension or suppression of operations associated with the trigger condition that initiated the evaluation of the content 510.

Similar to the previous examples, the graphical user interface 500a is generated by a frontend application, which is a browser application operably coupled to a web-based backend application or platform. The interface 500a can be rendered by a client device (e.g., client device 104, 106 of FIG. 1), which may be a personal electronic device such as a laptop, desktop computer, tablet and the like. The client device can include a display with an active display area in which the user interface 500a can be rendered. The user interface can be rendered by operation of an instance of a frontend application associated with a backend application that collectively define a software platform, as described herein. In some examples described herein, the graphical user interface 500a may be displayed subsequent to, or in response to, an authentication of a user of the content collaboration platform.

Similar to other examples provided herein, the graphical user interface 500a of FIG. 5A includes a content region 502 also referred to as a content panel, which displays the content 510 of a respective electronic document or page. Similar to as described with respect to other examples, the content 510 may include text content, selectable graphical objects, rich text content, images, videos, and other content. The content region 502 may include or operate an editor that is configured to receive user-generated content, which is used to generate or modify the content 510 of the document. As shown in FIG. 5A, the user-generated content or content 310 may include what is referred to as structured rich text content, which may be formatted in accordance with a formatting scheme, such as HTML, XML, Atlassian Document Format (ADF), or other similar scheme or language. The particular schema may also be referred to as a platform-specific or editor-specific formatting schema. In some examples, the text content can also be displayed in line with hypertext, graphical elements and other content that is enabled by the editor instantiated by the frontend application within the content region 502.

Also similar to other examples provided herein, the graphical user interface 500a also includes a navigational region 504, also referred to as a navigational panel, which includes a set of selectable elements 505 that are selectable to cause display of respective content items or navigate to other aspects of a document space. In this example, the navigational region 504 includes a hierarchical element tree 506 also referred to as a page tree, which includes an array of selectable tree elements 505 that are hierarchically arranged in accordance with parent-child relationships between respective documents of the document space. The elements may include a short title and/or graphical elements that indicate the subject matter and type of content item associated with each respective element. In the current example, the text used for the elements is the same as the title of the document and a modification of either the element text or the document title will result in a corresponding modification of the respective other text. That is, the user may edit a particular element 505 in the navigational region 504, which may cause the corresponding edits to appear in a respective title of the respective document. Conversely, an edit to a particular document title will cause corresponding edits to occur with respect to the respective element 505 in the navigational region 504. As discussed previously, the system may also use the document title to generate a URI or other path data that can be used to identify and access the respective document. Accordingly, a unique title (within the document space) may be necessary to provide operational functionality of the content collaboration platform.

FIG. 5B depicts a graphical user interface 500b, which may be generated subsequent to the operations and user selections described above with respect to FIG. 5A. Specifically, the graphical user interface 500b may be generated as a result of the supplemental content generation described above with respect to FIG. 2B. A description of many common elements of the graphical user interface 500 b with respect to 500a is not repeated here to reduce redundancy.

As shown in FIG. 5B, the graphical user interface 500b includes a graphical object 520, which now includes the generated recommended supplemental content 522. Specifically, the system may generate a recommended or proposed title text 522, which may be generated using the system and process described above with respect to FIG. 2B. The title text may also be displayed in the user-generated content 510 at an upper or top region of the document, as shown by the proposed document title 512 (example recommended supplemental content). In this example, the proposed title 512 replaces the placeholder object 511 depicted in FIG. 5A. In other examples, the proposed title 512 may be displayed within the placeholder object 511, which may help provide a visual distinction between the automatically generated content and the other user-generated content of the document.

As described previously with respect to FIG. 2B, the recommended supplemental content (in this case the title text 522, 512) may be generated using content extracted from other documents in the same hierarchical document structure. Specifically, the hierarchical element tree 506 may be a visual representation of the hierarchical document structure and depicts elements 505 that correspond to other documents in the document structure. The titles and/or the element text (which in this case are identical) may be extracted and included in a prompt provided to a generative output engine, which may use the reference content to generate title text that more closely corresponds to naming conventions and format of existing document titles. As also described above with respect to FIG. 2B, the system may perform a uniqueness evaluation or check to ensure that the proposed title is not identical with respect to other titles in the document structure. As described previously, if identical titles are detected, the system may modify the proposed title using one of the techniques described above with respect to FIG. 2B.

In the example interface 500b of FIG. 5B, the user may edit or modify the recommended supplemental content before accepting or adopting the proposal. In particular, the recommended supplemental content 522 displayed in the window object 520 may be rendered in an editor field, which may allow the user to modify the content 522 directly within the window object 520. Similarly, the recommended supplemental content 512 displayed in the content region 502 may be modified using the editor of the content region 502. Modifications to either of the instances of the recommended supplemental content 522, 512 may cause the respective other instance to be updated accordingly. In some cases, the modifications are performed concurrently, which may avoid multiple, different versions of the proposed text being displayed.

As shown in FIG. 5B, the user may accept or adopt the recommended supplemental content 522, 512 by providing user input to the window object 520. In this case, the window object 520 includes a control 524, which may be selected in order to accept or adopt the proposed text, which may have been further adapted or modified by the user, as discussed above. In some cases, an additional control is provided with respect to the supplemental content 512 displayed in the content region 502. FIG. 6B depicts an example of such a control 632. In some implementations, another control may be provided in the toolbar or elsewhere in the interface 500b for accepting or adopting the supplemental content. The selection of some controls may merely cause acceptance of the supplemental content and insertion of the supplemental content into the user-generated content. The selection of other controls, like control 524, may also cause automated completion or unsuspension of the operations associated with the trigger condition. By way of example, selection of control 524 may cause both automatic insertion of the supplemental content and automatic publication of the document.

In response to accepting or adopting the supplemental content, the corresponding text may be added to the user-generated content and the document. In some cases, the acceptance also causes an automatic saving of the document or other action that preserves the content in the content collaboration platform. Further, in some implementations, the operations or actions associated with the trigger may be resumed or un-suspended in response to the user acceptance of the supplemental content. Thus, if the trigger condition was associated with a request to publish the document (using control 509), the suspended publication operations may be resumed and the document may be published. Similarly, if the trigger condition was associated with a request to share the document (using control 508), the share operations may be resumed and the document or a link to the document may be transmitted to the designated recipients.

Further, in response to accepting or adopting the supplemental content, the system may generate or modify a corresponding element 505 of the hierarchical element tree 506 to reflect the accepted supplemental content. Specifically, a respective element 505 may be generated or modified to include the text of the supplemental content. In addition, the text or path of a uniform resource identifier associated with the current document may be generated or modified to include the text of the supplemental content. In some cases, other aspects of the content collaboration platform may also be modified or supplemented in response to the user acceptance of the supplemental content including, for example, a search index, content registry, or other aspects of the system.

FIGS. 6A-6B depict example graphical user interfaces of a content collaboration platform, as described herein. In particular, the graphical user interface 600a, 600b includes a content region 602, which may include or operate an editor configured to receive user-generated content. The graphical user interface 600a, 600b also includes a navigational region 604 or panel with a hierarchical element tree, similar to other examples, herein. Similar to previous examples described above, the content collaboration platform is a documentation platform and the graphical user interface 600a, 600b is a document or page viewing and/or editing interface for managing document or page content. The same or similar techniques described herein may also apply to other content items associated with other platforms including issue content of an issue managed by an issue tracking platform, project content or a project profile managed by project management platform or project directory service, or source code of a source code management platform or service.

The examples of FIGS. 6A-6B are directed to another type of supplemental content that may be generated by the system. Specifically, the example is directed to the automated generation and insertion of a recommended or proposed table-of-contents, which may be inserted into the content 610 of the current document. Similar to the example provided above with respect to FIGS. 5A-5B, the content generation and corresponding operations may be initiated in response to a trigger condition being satisfied. As described previously, the trigger condition may correspond to a user selection of a publication control 609, a content share control 608, or other similar action. Other trigger conditions are described above with respect to other examples and are not repeated to reduce redundancy. Further, as described previously, the operations or actions associated with the trigger may be suspended or paused momentarily until the generated supplemental content is accepted or adopted by the user.

Also similar to previous example, in response to the trigger condition being satisfied, the system may analyze the user-generated content 610 and, in response to the content satisfying a content criteria or sufficiency criteria, the system may cause generation of supplemental content. A more detailed description of this process is described above with respect to FIG. 2B and FIGS. 5A-5B. In this example, the system may identify or determine missing content component, which in this case is a table-of-contents. In response to identifying the missing content component, the system may cause display of a graphical object 611, which may be a box or region that is rendered in a location within the content 610. As described previously, the graphical object 611 may be a placeholder and may be replaced by or supplemented by the generated supplemental content. Further, similar to the previous example, the system may also cause display of a graphical object 620, which may include a notice regarding the generation operations and instructions regarding the automatically generated content and/or the operations associated with the trigger condition.

FIG. 6B depicts a graphical user interface 600b, which may be generated subsequent to the operations and user selections described above with respect to FIG. 6A. Specifically, the graphical user interface 600b may be generated as a result of the supplemental content generation described above with respect to FIG. 2B. A description of many common elements of the graphical user interface 600b with respect to 600a is not repeated here to reduce redundancy.

As shown in FIG. 6B, the graphical user interface 600b includes a graphical object 620, which may include updated information 622 about the generation of the supplemental content and may include instructions for proceeding or accepting the recommended content. The supplemental content may also be included in the graphical object 620, depending on the size or area required to display the supplemental content. Here, the table-of-contents is too large to be displayed within the area of the window object 620 so the display of the supplemental content is suppressed or omitted. Further, the system may cause generation of the recommended supplemental content 612 within the content panel 602. In this example, the placeholder object 611 is replaced with the recommended supplemental content 612. In other examples, the supplemental content 612 may be displayed within the object 611. Here, the supplemental content 612 is displayed within a frame 630 or box, which may provide a visual distinction between the automatically generated content and the other user-generated content 610. Similar to the previous examples described herein, the user may provide modifications or edits to the supplemental content 612 via the editor of the content region 602.

As shown in FIG. 6B, the user may accept or adopt the recommended supplemental content 612 by providing user input to the window object 620. In this case, the window object 620 includes a control 624, which may be selected in order to accept or adopt the proposed text. The interface 600b also includes a control 632 that is provided with respect to the supplemental content 612 displayed in the content region 602. In some implementations, another control may be provided in the toolbar or elsewhere in the interface 600b for accepting or adopting the supplemental content. The selection of some controls (e.g., 632) may merely cause acceptance of the supplemental content and insertion of the supplemental content into the user-generated content. The selection of other controls (e.g., 624) may also cause automated completion or unsuspension of the operations associated with the trigger condition. By way of example, selection of control 624 may cause both automatic insertion of the supplemental content and automatic publication of the document.

In response to accepting or adopting the supplemental content, the corresponding text may be added to the user-generated content and the document. In some cases, the acceptance also causes an automatic saving of the document or other action that preserves the content in the content collaboration platform. Further, in some implementations, the operations or actions associated with the trigger may be resumed or un-suspended in response to the user acceptance of the supplemental content. Thus, if the trigger condition was associated with a request to publish the document (using control 609), the suspended publication operations may be resumed and the document may be published. Similarly, if the trigger condition was associated with a request to share the document (using control 608), the share operations may be resumed and the document or a link to the document may be transmitted to the designated recipients.

These foregoing embodiments depicted in FIG. 2A-6B and the various alternatives thereof and variations thereto are presented, generally, for purposes of explanation, and to facilitate an understanding of various configurations and constructions of a system and related user interfaces and methods of interacting with those interfaces, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings. For example, it may be appreciated that a common editor frame is only one method of providing input to, and receiving output from, a generative output engine as described herein.

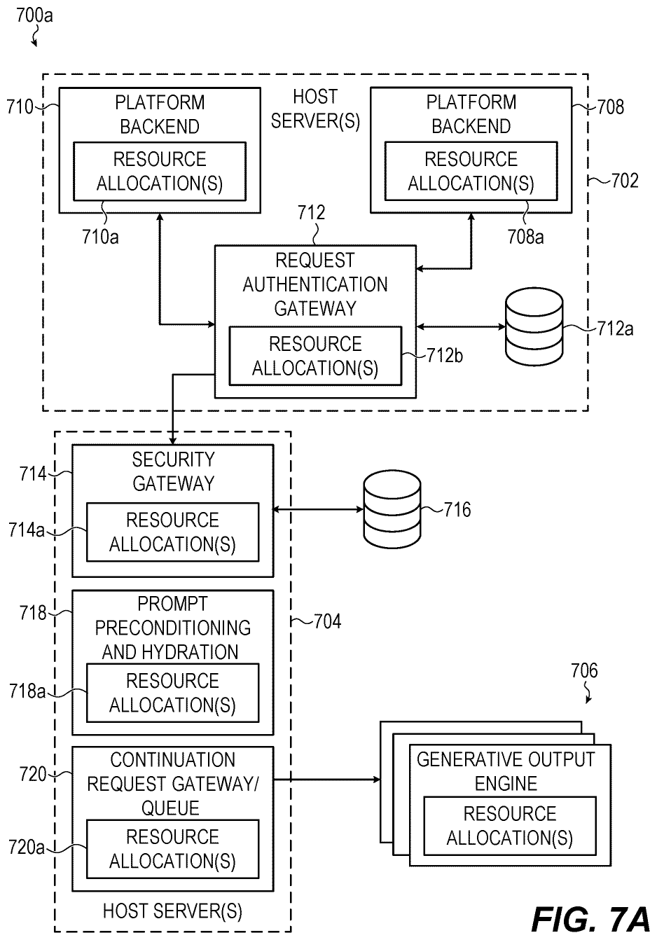

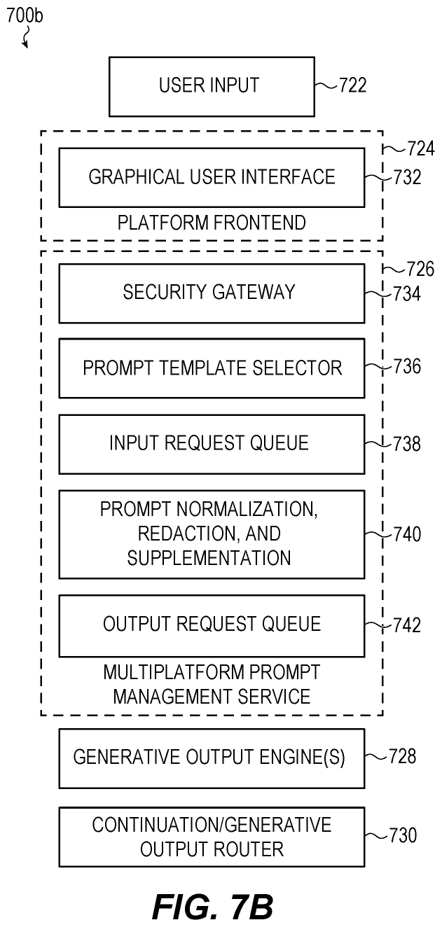

FIGS. 7A-7B depicts system diagrams and network/communication architectures that may support a system as described herein. Referring to FIG. 7A, the system 700a includes a first set of host servers 702 associated with one or more software platform backends. These software platform backends can be communicably coupled to a second set of host servers 704 purpose configured to process requests and responses to and from one or more generative output engines 706.

Specifically, the first set of host servers 702 (which, as described above can include processors, memory, storage, network communications, and any other suitable physical hardware cooperating to instantiate software) can allocate certain resources to instantiate a first and second platform backend, such as a first platform backend 708 and a second platform backend 710. Each of these respective backends can be instantiated by cooperation of processing and memory resources associated to each respective backend. As illustrated, such dedicated resources are identified as the resource allocations 708a and the resource allocations 710a.

Each of these platform backends can be communicably coupled to an authentication gateway 712 configured to verify, by querying a permissions table, directory service, or other authentication system (represented by the database 712a) whether a particular request for generative output from a particular user is authorized. Specifically, the second platform backend 710 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 712 can deny the request for insufficient permissions. This example is merely one and is not intended to be limiting; many possible authorization and authentication operations can be performed by the authentication gateway 712. The authentication gateway 712 may be supported by physical hardware resources, such as a processor and memory, represented by the resource allocations 712b.

Once the authentication gateway 712 determines that a request from a user of either platform is authorized to access data or resources implicated in service that request, the request may be passed to a security gateway 714, which may be a software instance supported by physical hardware identified in FIG. 7A as the resource allocations 714a. The security gateway 714 may be configured to determine whether the request itself conforms to one or more policies or rules (data and/or executable representations of which may be stored in a database 716) established by the organization. For example, the organization may prohibit executing prompts for offensive content, value-incompatible content, personally identifying information, health information, trade secret information, unreleased product information, secret project information, and the like. In other cases, a request may be denied by the security gateway 714 if the prompt requests beyond a threshold quantity of data.

Once a particular user-initiated prompt has been sufficiently authorized and cleared against organization-specific generative output rules, the request/prompt can be passed to a preconditioning and hydration service 718 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 718 can be a software instance supported by physical hardware represented by the resource allocations 718a. In some implementations, the hydration service 718 may also be used to rehydrate personally identifiable information (PII) or other potentially sensitive data that has been extracted from a request or data exchange in the system.

One a prompt has been modified, replaced, or hydrated by the preconditioning and hydration service 718, it may be passed to an output gateway 720 (also referred to as a continuation gateway or an output queue). The output gateway 720 may be responsible for enqueuing and/or ordering different requests from different users or different software platforms based on priority, time order, or other metrics. The output gateway 720 can also serve to meter requests to the generative output engines 706.

FIG. 7B depicts a functional system diagram of the system 700a depicted in FIG. 7A. In particular, the system 700b is configured to operate as a multiplatform prompt management service supporting and ordering requests from multiple users across multiple platforms. In particular, a user input 722 may be received at a platform frontend 724. The platform frontend 724 passes the input to a prompt management service 726 that formalizes a prompt suitable for input to a generative output engine 728, which in turn can provide its output to an output router 760 that may direct generative output to a suitable destination. For example, the output router 760 may execute API requests generated by the generative output engine 728, may submit text responses back to the platform frontend 724, may wrap a text output of the generative output engine 728 in an API request to update a backend of the platform associated with the platform frontend 724, or may perform other operations.

Specifically, the user input 722 (which may be an engagement with a button, typed text input, spoken input, chat box input, and the like) can be provided to a graphical user interface 732 of the platform frontend 724. The graphical user interface 732 can be communicably coupled to a security gateway 734 of the prompt management service 726 that may be configured to determine whether the user input 722 is authorized to execute and/or complies with organization-specific rules.

The security gateway 734 may provide output to a prompt selector 736 which can be configured to select a prompt template from a database of preconfigured prompts, templatized prompts, or engineered templatized prompts. Once the raw user input is transformed into a string prompt, the prompt may be provided as input to a request queue 738 that orders different user request for input from the generative output engine 728. Output of the request queue 738 can be provided as input to a prompt hydrator 740 configured to populate template fields, add context identifiers, supplement the prompt, and perform other normalization operations described herein. In other cases, the prompt hydrator 740 can be configured to segment a single prompt into multiple discrete requests, which may be interdependent or may be independent.

Thereafter, the modified prompt(s) can be provided as input to an output queue at 742 that may serve to meter inputs provided to the generative output engine 728.

These foregoing embodiments depicted in FIGS. 7A-7B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

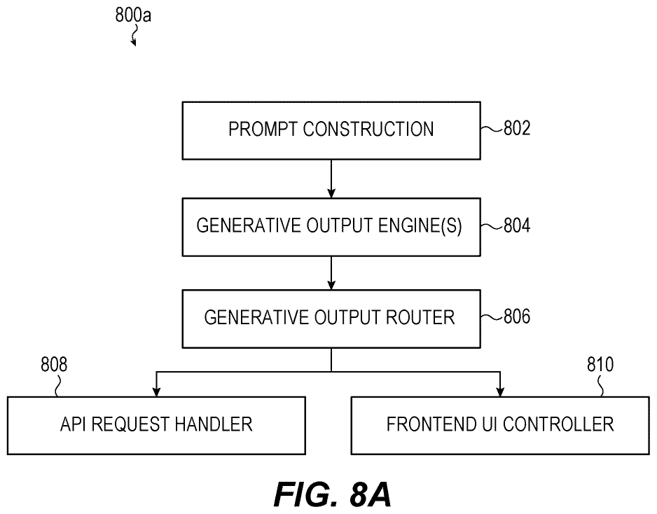

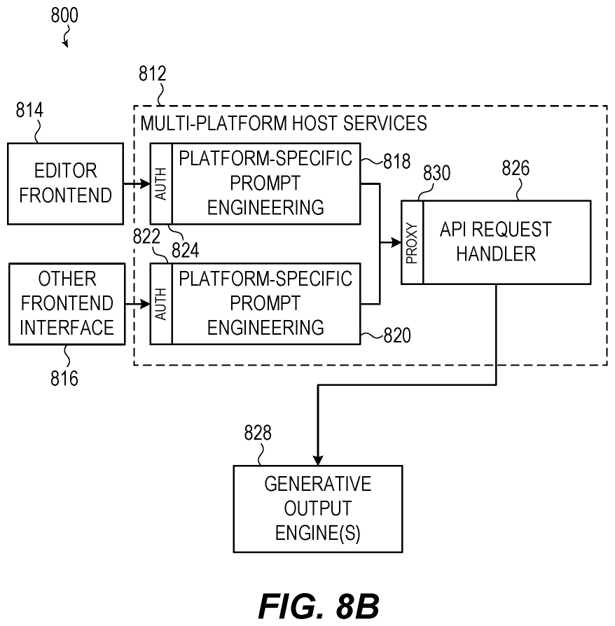

For example, although many constructions are possible, FIG. 8A depicts a simplified system diagram and data processing pipeline as described herein. The system 800a receives user input, and constructs a prompt therefrom at operation 802. After constructing a suitable prompt, and populating template fields, selecting appropriate instructions and examples for an LLM to continue, the modified constructed prompt is provided as input to a generative output engine 804. A continuation from the generative output engine 804 is provided as input to a router 806 configured to classify the output of the generative output engine 804 as being directed to one or more destinations. For example, the router 806 may determine that a particular generative output is an API request that should be executed against a particular API (e.g., such as an API of a system or platform as described herein). In this example, the router 806 may direct the output to an API request handler 808. In another example, the router 806 may determine that the generative output may be suitably directed to a graphical user interface/frontend. For example, a generative output may include suggestions to be shown to a user below a user's partial input, for example for an input as shown in FIGS. 2-10.

Another example architecture is shown in FIG. 8B, illustrating a system providing prompt management, and in particular multiplatform prompt management as a service. The system 800b is instantiated over cloud resources, which may be provisioned from a pool of resources in one or more locations (e.g., datacenters). In the illustrated embodiment, the provisioned resources are identified as the multi-platform host services 812.

The multi-platform host services 812 can receive input from one or more users in a variety of ways. For example, some users may provide input via an editor region 814 of a frontend, such as described above. Other users may provide input by engaging with other user interface elements 816 unrelated to common or shared features across multiple platforms. Specifically, the second user may provide input to the multi-platform host services 812 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 812 can include multiple software instances or microservices each configured to receive user inputs and/or proposed prompts and configured to provide, as output, an engineered prompt. In many cases, these instances—shown in the figure as the platform-specific prompt engineering services 818, 820—can be configured to wrap proposed prompts within engineered prompts retrieved from a database such as described above.

In many cases, the platform-specific prompt engineering services 818, 820 can be each configured to authenticate requests received from various sources. In other cases, requests from editor regions or other user interface elements of particular frontends can be first received by one or more authenticator instances, such as the authentication instances 822, 824. In other cases, a single centralized authentication service can provide authentication as a service to each request before it is forwarded to the platform-specific prompt engineering services 818, 820.

Once a prompt has been engineered/supplemented by one of the platform-specific prompt engineering services 818, 820, it may be passed to a request queue/API request handler 826 configured to generate an API request directed to a generative output engine 828 including appropriate API tokens and the engineered prompt as a portion of the body of the API request. In some cases, a service proxy 830 can interpose the platform-specific prompt engineering services 818, 820 and the request queue/API request handler 826, so as to further modify or validate prompts prior to wrapping those prompts in an API call to the generative output engine 828 by the request queue/API request handler 826 although this is not required of all embodiments.

These foregoing embodiments depicted in FIGS. 7A-7B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

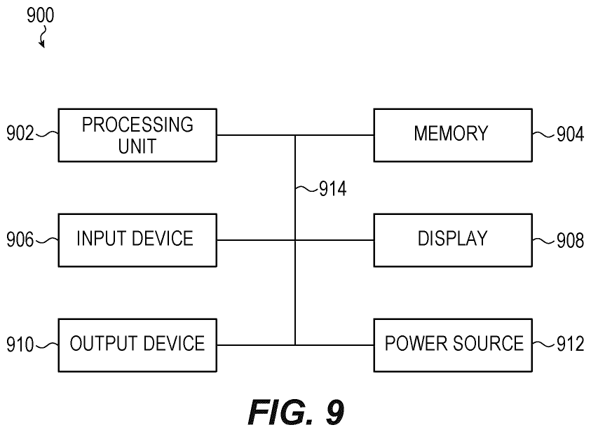

FIG. 9 shows a sample electrical block diagram of an electronic device 900 that may perform the operations described herein. The electronic device 900 may in some cases take the form of any of the electronic devices described with reference to FIG. 1-8B, including client devices, and/or servers or other computing devices associated with the system 100. The electronic device 900 can include one or more of a processing unit 902, a memory 904 or storage device, input devices 906, a display 908, output devices 910, and a power source 912. In some cases, various implementations of the electronic device 900 may lack some or all of these components and/or include additional or alternative components.

The processing unit 902 can control some or all of the operations of the electronic device 900. The processing unit 902 can communicate, either directly or indirectly, with some or all of the components of the electronic device 900. For example, a system bus or other communication mechanism 914 can provide communication between the processing unit 902, the power source 912, the memory 904, the input device(s) 906, and the output device(s) 910.

The processing unit 902 can be implemented as any electronic device capable of processing, receiving, or transmitting data or instructions. For example, the processing unit 902 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 900 can be controlled by multiple processing units. For example, select components of the electronic device 900 (e.g., an input device 906) may be controlled by a first processing unit and other components of the electronic device 900 (e.g., the display 908) may be controlled by a second processing unit, where the first and second processing units may or may not be in communication with each other.

The power source 912 can be implemented with any device capable of providing energy to the electronic device 900. For example, the power source 912 may be one or more batteries or rechargeable batteries. Additionally, or alternatively, the power source 912 can be a power connector or power cord that connects the electronic device 900 to another power source, such as a wall outlet.

The memory 904 can store electronic data that can be used by the electronic device 900. For example, the memory 904 can store electronic data or content such as, for example, audio and video files, documents and applications, device settings and user preferences, timing signals, control signals, and data structures or databases. The memory 904 can be configured as any type of memory. By way of example only, the memory 904 can be implemented as random access memory, read-only memory, flash memory, removable memory, other types of storage elements, or combinations of such devices.

In various embodiments, the display 908 provides a graphical output, for example associated with an operating system, user interface, and/or applications of the electronic device 900 (e.g., a chat user interface, an issue-tracking user interface, an issue-discovery user interface, etc.). In one embodiment, the display 908 includes one or more sensors and is configured as a touch-sensitive (e.g., single-touch, multi-touch) and/or force-sensitive display to receive inputs from a user. For example, the display 908 may be integrated with a touch sensor (e.g., a capacitive touch sensor) and/or a force sensor to provide a touch-and/or force-sensitive display. The display 908 is operably coupled to the processing unit 902 of the electronic device 900.

The display 908 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 908 is positioned beneath and viewable through a cover that forms at least a portion of an enclosure of the electronic device 900.

In various embodiments, the input devices 906 may include any suitable components for detecting inputs. Examples of input devices 906 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 906 may be configured to detect one or more particular types of input and provide a signal (e.g., an input signal) corresponding to the detected input. The signal may be provided, for example, to the processing unit 902.

As discussed above, in some cases, the input device(s) 906 includes a touch sensor (e.g., a capacitive touch sensor) integrated with the display 908 to provide a touch-sensitive display. Similarly, in some cases, the input device(s) 906 includes a force sensor (e.g., a capacitive force sensor) integrated with the display 908 to provide a force-sensitive display.

The output devices 910 may include any suitable components for providing outputs. Examples of output devices 910 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 910 may be configured to receive one or more signals (e.g., an output signal provided by the processing unit 902) and provide an output corresponding to the signal.

In some cases, input devices 906 and output devices 910 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 902 may be operably coupled to the input devices 906 and the output devices 910. The processing unit 902 may be adapted to exchange signals with the input devices 906 and the output devices 910. For example, the processing unit 902 may receive an input signal from an input device 906 that corresponds to an input detected by the input device 906. The processing unit 902 may interpret the received input signal to determine whether to provide and/or change one or more outputs in response to the input signal. The processing unit 902 may then send an output signal to one or more of the output devices 910, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method for generating and displaying suggested content recommendations within a graphical user interface of a content collaboration platform, the method comprising:
in accordance with a successful authentication of a user operating a frontend application on a client device, causing display of the graphical user interface of the content collaboration platform, the graphical user interface including a content region including an editor configured to receive user-generated content of a current document;
in response to a trigger condition being satisfied, analyze the user-generated content of the current document to determine a set of document content nodes;
for each node of at least a subset of nodes of the set of document content nodes:
analyzing content of a respective node of the subset of nodes to determine a content node type for the respective node;
selecting a content recommendation engine from a set of available content recommendation engines based on the content node type;
in accordance with the content recommendation engine being a generative recommendation engine, causing generation of a prompt comprising:
predetermined query prompt text including text-based instructions; and
at least a portion of the content of the respective node;
obtaining a generative response from a generative output engine, the generative response produced in response to the prompt being provided to the generative output engine;
causing display of a recommendation region within the graphical user interface;
causing display of a set of selectable recommendation objects in the recommendation region, each selectable recommendation region corresponding to a node of the set of nodes; and
in response to a user input with respect to a particular selectable recommendation object of the set of selectable recommendation objects, cause display of a particular output based on a particular generative response corresponding to the particular selectable recommendation object in the graphical user interface.

2. The computer-implemented method of claim 1, wherein:
analyzing the content of the respective node of the subset of nodes to determine the content type for the respective node comprises:
processing content of the respective node using a first content recommendation engine of the set of recommendation engines to obtain a first analysis result;
processing content of the respective node using a second content recommendation engine of the set of recommendation engines to obtain a second analysis result;
processing content of the respective node using a third content recommendation engine of the set of recommendation engines to obtain a third analysis result; and
analyzing the first, second, and third results to determine the content node type.

3. The computer-implemented method of claim 1, wherein:
the first analysis result includes a first confidence score;
the second analysis result includes a second confidence score;
the third analysis result includes a third confidence score; and
the content node type is determined based on an evaluation of the first, second, and third confidence scores.

4. The computer-implemented method of claim 1, wherein:
analyzing the content of the respective node of the subset of nodes to determine the content type for the respective node comprises providing the content to a content classification model;
the content classification model is trained using existing content nodes and a set of predetermined content node types; and
the set of predetermined content node types include one or more of a narrative content node type, a panel content node type, or a table content node type.

5. The computer-implemented method of claim 1, wherein:
generation of the prompt further comprises:
extracting user-specific data from a user profile associated with the authenticated user operating the frontend application; and
adding at least a portion of the user-specific data to the prompt.

6. The computer-implemented method of claim 1, wherein:
the user input is a first user input;
the output based on the particular generative response includes a natural language narrative;
in response to the first user input, the natural language narrative is displayed in a window object overlapping at least a portion of the content region of the graphical user interface; and
in response to a second user input with respect to the window object, replacing content corresponding to the respective node with the content corresponding to the natural language narrative.

7. The computer-implemented method of claim 6, wherein:
the content corresponding to the respective node includes editor-specific rich text elements; and
the content corresponding to the natural language narrative includes one or more of the editor-specific rich test elements.

8. The computer-implemented method of claim 1, wherein:
the prompt is a first prompt;
the predetermined query prompt text is first predetermined query prompt text;
the generative response is a first generative response;
in accordance with the content recommendation engine being a table generation engine, causing generation of a second prompt comprising:
second predetermined query prompt text including instructions regarding table generation; and
at least a portion of the content of the respective node;
obtaining a second generative response from the generative output engine; and
in response to a user input with respect to a respective selectable recommendation object that corresponds to the second generative response, cause display of a recommended table in the graphical user interface.

9. The computer-implemented method of claim 1, wherein the trigger condition is at least one of:
a document save condition;
a document publish condition; or
a user input condition.

10. A system of a content collaboration platform, the system comprising:
one or more processing units;
computer readable memory storing computer readable instructions that when executed by the one or more processing units cause the system to:
cause display of a graphical user interface of the content collaboration platform on a client device, the graphical user interface including:
a content region operating an editor configured to receive user input for a current document; and
a navigational region including a hierarchical element tree having a set of hierarchically arranged elements, each element selectable to cause display of respective document content of a respective document in the content region;
in response to a trigger condition being satisfied, analyze document content of the current document to determine a set of document content segments;
for each segment of at least a subset of segments of the set of document content segments:
select a content recommendation engine from a set of available content recommendation engines based on an analysis of segment content of a respective document content segment;
in accordance with the content recommendation engine being a generative recommendation engine, cause generation of a prompt comprising:
predetermined query prompt text including text-based instructions; and
at least a portion of the segment content of the respective document content segment;
obtain a generative response from a generative output engine, the generative response produced in response to the prompt being provided to the generative output engine;
cause display of a set of selectable recommendation objects in a recommendation region of the graphical user interface, each selectable recommendation region corresponding to a document content segment of the set of document content segments; and
in response to a user input with respect to a particular selectable recommendation object of the set of selectable recommendation objects, cause display of a recommendation segment of a particular generative response corresponding to the particular selectable recommendation object in the graphical user interface.

11. The system of claim 10, wherein:
instructions for selecting the content recommendation engine from the set of available content recommendation engines comprises:
processing content of the respective document content segment using a first content recommendation engine of the set of recommendation engines to obtain a first analysis result;
processing content of the respective document content segment using a second content recommendation engine of the set of recommendation engines to obtain a second analysis result;
processing content of the respective document content segment using a third content recommendation engine of the set of recommendation engines to obtain a third analysis result; and
analyzing the first, second, and third results to select the content recommendation engine.

12. The system of claim 10, wherein:
the particular generative response is displayed in a window object of the graphical user interface; and
the window object is configured to modify the particular generative response in response to additional input provided to the window object.

13. The system of claim 10, wherein a hover user input provided to the particular selectable recommendation object causes the graphical user interface to highlight a particular document content segment that corresponds to the particular selectable recommendation object.

14. The system of claim 10, wherein:
the particular generative response is saved in a content store of the content collaboration platform;
subsequent to a modification of a particular document content segment that corresponds to the particular generative response, causing generation of an updated generative response; and
saving the updated generative response om the content store of the content collaboration platform.

15. The system of claim 10, wherein the trigger condition is at least one of:
a document save condition;
a document publish condition; or
a user input condition.

16. The system of claim 10, wherein:
the particular selectable recommendation object comprises:
a content type associated with a particular document content segment associated with the particular selectable recommendation object; and
a selectable control to cause the generative response to replace the particular document content segment within the document content.

17. A computer-implemented method generating content in a content collaboration platform, the method comprising:
authenticating a user with respect to a frontend application on a client device
subsequent to authenticating the user, causing display of a document in a content region of a graphical user interface of the content collaboration platform;
analyzing document content of the document to determine a set of document content nodes;
for a document content node of the set of document content nodes:
selecting a content recommendation engine from a set of available content recommendation engines based on an analysis of node content of the document content node;
in accordance with the content recommendation engine being a narrative generation engine, causing generation of a first prompt comprising:
first predetermined query prompt text; and
at least a portion of the content of the document content node;
obtaining a first generative response from a generative output engine, the first generative response produced in response to the first prompt being provided to the generative output engine;
in accordance with the content recommendation engine being a table generation engine, causing generation of a second prompt comprising:
second predetermined query prompt text; and
the at least the portion of the content of the document content node;
obtaining a second generative response from a generative output engine, the second generative response produced in response to the second prompt being provided to the generative output engine;
causing display of a set of selectable recommendation objects within a recommendation region of the graphical user interface, the set of selectable recommendation objects including a particular selectable recommendation object that corresponds to the document content node;
in response to a user input and in accordance with the content recommendation engine being the narrative generation engine, causing display of a first output based the first generative response in the graphical user interface; and
in response to the user input and in accordance with the content recommendation engine being the table generation engine, causing display of a second output based on the second generative response in the graphical user interface.

18. The computer-implemented method of claim 17, wherein:
the first output based on the first generative response includes a natural language narrative; and
the second output based on the second generative response includes a table of content.

19. The computer-implemented method of claim 17, wherein:
the first output or the second output is displayed in a window object within the graphical user interface; and
an input with respect to the window object causes document content corresponding to the document content node to be replaced with the first output or the second output.

20. The computer-implemented method of claim 17, wherein:
the recommendation region is displayed adjacent to the content region; and
in response to an input to the graphical user interface, the recommendation region is hidden from display within the graphical user interface.

21. The computer-implemented method of claim 17, wherein selecting the content recommendation engine from the set of content recommendation engines comprises analyzing the node content of the document content node to determine a content node type; and
the content node type one or more of: narrative content node type, a panel content node type, or a table content node type.
